(19) United States
(12) Patent Application Publication
(10) Pub. No.: US 2023/0059114 A1
(43) Pub. Date: Feb. 23, 2023

(54) APPARATUSES WITH SIGNAGE RETENTION FEATURES

(71) Applicant: Louise St. Clair LICKFELD, Tustin, CA (US)

(72) Inventor: Louise St. Clair LICKFELD, Tustin, CA (US)

(21) Appl. No.: 17/074,529

(22) Filed: Oct. 19, 2020

Related U.S. Application Data
(60) Provisional application No. 62/923,423, filed on Oct. 18, 2019.

(51) Int. Cl. G09F 7/18; G09F 7/10

(52) U.S. Cl. CPC G09F 7/18; G09F 7/10; G09F 2007/1813

(57) ABSTRACT

The present disclosure provides various embodiments of an apparatus configured to receive and hold signage, such as advertising and/or marketing content, and to increase visibility of such signage in order to free up space on a surface, such as a tabletop. The apparatus may be portable and/or modular. The apparatus may include a body having an outer surface and an inner surface. The inner surface may at least partially circumscribe a gap configured to receive a support structure. The apparatus may further include at least one extension extending from the outer surface of the body and having a first finger and a second finger separated by a groove. At least the first finger may be deformable away from the second finger to increase the separation by the groove and at least the first finger being configured to exert force toward the second finger when deformed.

### CROSS REFERENCE TO RELATED APPLICATION

This application claims priority to U.S. Provisional Application No. 62/923,423, entitled “PORTABLE MODULAR POLE MOUNTED ADVERTISEMENT HOLDING DEVICE” and filed on Oct. 18, 2019, the disclosure of which is expressly incorporated herein in its entirety.

### BACKGROUND

### Technical Field

The present disclosure relates generally to apparatuses configured to be mounted on support structures, and more particularly, to support structure-mounted apparatuses configured to engage and retain signage.

### INTRODUCTION

The placement and/or display of signage, such as advertising and/or marketing content or other informational content, may limited to placement on horizontal surfaces, such as tabletop surfaces, and/or fastened to a wall (e.g., using nails and/or adhesives). Placing such signage on a tabletop surface or fastened on a wall may be inconvenient for some users, e.g., as such placement may not be within a user's line of sight. Moreover, signage positioned on a horizontal surface may consume space that may be used for other items (e.g., table settings, dishes, glasses, other containers, other advertising/marketing content, or the like), while fastening signage to a wall may cause damage to the wall and/or the signage itself. The conventional materials used for some signage, such as advertisements, menus, fliers, informational notices, and the like, are often relatively light-weight, easily damaged, and/or easily displaced or lost due to various conditions, such as wind or other inclement weather, intentional or unintentional displacement by individuals, and/or general carelessness or negligence.

Previous attempts to overcome issues related to the displacement and/or damage inflicted on some signage that is relatively light-weight, moveable, and/or inexpensive have included brackets that attach signs or advertising content to poles. However, brackets fastened to poles or other support structures conventionally employ at least two complementary or opposing sides, which are disposed around a pole or other support structure and then mechanically fastened together using a set of bolts and/or screws. Absent such a complementary arrangement, the bracket would have to be either co-manufactured with the pole or other support structure or fitted over an open end of the pole or other support structure and then moved into position; however, neither the former nor the latter is practical in most situations.

Furthermore, signage used with many types of brackets, as well as the brackets themselves, may be formed of metal or other materials (e.g., wood, plastic, paper, etc.) susceptible to environmental conditions. Consequently, brackets and/or signage secured thereby may become corroded or damaged, e.g., over a relatively short period of time (e.g., days or even hours, in the case of paper/cardboard signage), causing the brackets and/or signage to become less aesthetically appealing, displaced from an intended position, unreadable, etc.

In addition, conventional brackets often secure signage in inconvenient ways—e.g., a bracket may secure signage by traversing an opening through the signage material. In order to do so, the signage is either pierced or the signage should be prepared with opening(s) designed to receive features from the bracket that secure the signage to the bracket. Both of the foregoing approaches present appreciable drawbacks. In the case of piercing the signage, the signage may become damaged, which may prevent the signage from conveying a message (e.g., text may be unreadable). In the case of designing signage with opening(s) configured to receive bracket features, the signage would have to be created or altered to include such opening(s), which may introduce additional overhead cost and time expenditures.

In some instances, such brackets may not be easily removable. Also, the signage itself may not be easily removable from and/or replaceable in these brackets. Rather, such brackets (e.g., metal brackets) are often intended to be permanent or to remain in place over extended durations, such as weeks, months, or even longer. Illustratively, street and other road signs, holiday event banners, retail location signs, and/or directional or other informational signs may be secured using metal brackets that are neither easily removable nor easily reconfigured to secure different signs.

In view of the foregoing, a need exists for techniques and approaches to retaining signage, e.g., in order to improve the manner in which signage is displayed and arranged, while freeing up space on a tabletop surface and allowing for the signage to be easily replaced.

### SUMMARY

The following presents a simplified summary of one or more aspects in order to provide a basic understanding of such aspects. This summary is not an extensive overview of all contemplated aspects, and is not necessarily intended to identify either key or critical elements of all aspects nor delineate the scope of any or all aspects. Its sole purpose is to present some concepts of one or more aspects in a simplified form as a prelude to the more detailed description that is presented later.

In various aspects of the present disclosure, signage may include any printed or written means to convey information, such as advertising or marketing content, menus, informational notices, one sheets, fact sheets, fliers, pamphlets, brochures, and the like. For example, signage may include text and/or images printed or otherwise transcribed or transposed onto a material, such as paper, plastic, wood, etc. In some aspects, signage may include more than one material—e.g., signage may include paper having text printed thereon that is laminated. Potentially, signage may be intended for temporary or short-term use, such as on a scale of hours, days, or weeks (although other durations are also contemplated by the present disclosure). The foregoing is to be considered illustrative, and is not intended to limit the scope of the present disclosure.

In many contexts, signage may be placed on a stand or holding device on a tabletop in order to increase visibility of the content. However, placing signage in such stands or holding devices may limit the visibility of the content printed thereon to marginally above the height of the tabletop, which may be below the line of sight of the many individuals.

In addition, signage placed on a tabletop or other surface consumes space, which otherwise might be used for different purposes (e.g., for table settings, comestibles, etc.). Further, arranging signage to be vertically oriented (e.g., to improve readability and/or capture a person's attention) on a horizontal surface may involve attaching the signage to a separate base or constructing signage with complicated patterns or designs to facilitate folding or configuring such signage to serve as its own vertical stand.

As an alternative to placement on a horizontal surface, signage may be vertically mounted, e.g., on a wall. However, conventional mechanical fasteners may pierce or otherwise damage the signage material and/or the support structures to which they are mounted. Moreover, conventional mechanical fasteners generally secure signage in a manner that does not lend itself to convenient and expeditious replacement of signage. Other approaches to presentation of signage, such as mounting signage on a wall may cause the signage to be too remote from an intended audience to capture their attention, and further, may involve damaging the wall or signage using adhesive, nails, or other mounting mechanism.

The present disclosure provides various techniques and solutions to presenting signage so that the content of the signage is readily discernable and is also easily and quickly replaceable. To that end, the present disclosure describes various apparatuses that at least partially circumscribe a pole or other support structure, and further, secure or retain signage for suitable presentation in a way that does not reduce horizontal surface space, such as on a tabletop. The various aspects described by the present disclosure may be applicable in a variety of different contexts, such as for presentation of advertising or other marketing content, menus, one sheets, fact sheets, fliers, brochures, pamphlets, informational notices, and so forth.

In an aspect of the disclosure, an apparatus for retaining signage is described. The apparatus includes a body having an outer surface and an inner surface, and the inner surface at least partially circumscribes a gap configured to receive a support structure. The apparatus further includes at least one extension extending from the outer surface of the body and having a first finger and a second finger separated by a groove. At least the first finger is deformable away from the second finger to increase the separation by the groove, and at least the first finger is configured to exert force toward the second finger when deformed.

In another aspect of the disclosure, another apparatus for retaining signage is described. The other apparatus includes a collar configured to engage with a support structure. The other apparatus further includes a first protrusion outwardly extending from the collar and having a first proximal end connected with the collar. The other apparatus further includes a second protrusion outwardly extending from the collar and having a second proximal end connected with the collar, and the first proximal end is separated from the second proximal end, and at least a first distal end of the first protrusion is configured to apply pressure toward a second distal end of the second protrusion to retain a signage therebetween.

In a further aspect of the disclosure, a further apparatus for retaining signage is described. The further apparatus includes a cylindrical bracket portion having at least partially surrounding a center opening. The further apparatus also includes at least one signage retention feature on an exterior of the cylindrical bracket portion. The at least one signage retention feature includes a first protrusion and a second protrusion, and the first and second protrusions are configured to exert opposing forces on signage positioned therebetween.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a perspective view of an apparatus, according to some embodiments of the present disclosure.

FIGS. 2A and 2B are overhead perspective views of embodiments of the apparatus and at least one extension of the apparatus, according to some embodiments of the present disclosure.

FIGS. 3A, 3B, 3C, and 3D are overhead perspective views of embodiments of the body of the apparatus, according to some embodiments of the present disclosure.

FIG. 4 is another perspective view of embodiments of the apparatus, according to some embodiments of the present disclosure.

FIGS. 5A, 5B, 5C, and 5D are side perspective views of embodiments of the apparatus and extensions thereof, according to some embodiments of the present disclosure.

FIG. 6 are overhead perspective views of embodiments of grooves formed by extensions of the apparatus, according to some embodiments of the present disclosure.

FIG. 7 are overhead perspective views of embodiments of extensions of the apparatus, according to some embodiments of the present disclosure.

FIGS. 8A, 8B, and 8C are overhead perspective views of embodiments of the apparatus, according to some embodiments of the present disclosure.

FIG. 9 is another overhead perspective view of embodiments of the apparatus, according to some embodiments of the present disclosure.

FIG. 10 are other overhead perspective views of embodiments of the apparatus, according to some embodiments of the present disclosure.

FIG. 11 is a perspective view of embodiments of the apparatus mounted on a support structure and retaining signage, according to some embodiments of the present disclosure.

FIG. 12 is another perspective view of embodiments of apparatuses mounted on a support structure and retaining signage, according to some embodiments of the present disclosure.

FIG. 13 is a further perspective view of embodiments of the apparatus mounted on a support structure and retaining signage, according to some embodiments of the present disclosure.

FIG. 14 is an overhead perspective view of embodiments of the apparatus in which the at least one extension forms a groove with a texture, according to some embodiments of the present disclosure.

FIG. 15 is an overhead perspective view of embodiments of the at least one extension forming a groove with a texture, according to some embodiments of the present disclosure.

FIG. 16 is another overhead perspective view of embodiments of the at least one extension forming a groove with another texture, according to some embodiments of the present disclosure.

FIG. 17 is a further overhead perspective view of embodiments of the at least one extension forming a groove with a further texture, according to some embodiments of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Signage, such as promotional or advertising content, fliers, brochures, one sheets, fact sheets, pamphlets, etc., may be displayed on tabletops or other horizontal surfaces, e.g., in an effort to grab the attention of patrons or other users of the table. Such signage positioned on horizontal surfaces may either lay flat on the surface, or may be positioned to be vertical on the horizontal surface. For example, the signage may be arranged to stand on the tabletop by being placed in holding device. However, configuring the material in such a manner may impede the experience of the patron or user. The signage on the surface (e.g., tabletop) may take up some of the surface space, consequently limiting or reducing surface space available to accommodate their items. In some instances, signage (e.g., promotional or advertising content) that occupies space on a surface may be moved out of the way or even discarded entirely by users if taking up too much space or impeding the user experience. In such instances, users will not pay attention to the signage, which may defeat the purpose of having placed signage near users' positions in the first place.

In some instances, signage may be mounted with mechanical fasteners. The signage and/or mechanical fasteners may corrode over time and/or cause damage to the signage. The signage may not be easily removed and switched out from these mechanical fasteners. In some instances, the mechanical fasteners may be intended to be used as a long-term solution, and so the signage may be tightly secured by the mechanical fasteners.

According to various embodiments of the present disclosure, apparatuses, such as portable modular brackets, may allow for the increased visibility of signage (e.g., advertising or marketing content) while simultaneously freeing up space on the various surfaces, such as tabletops. The apparatus may be utilized to remove the signage off of the tabletop or other surface, and instead position the signage onto a supporting structure, such as an umbrella pole. The apparatuses may further mount signage onto supporting structures (e.g., poles), and may also facilitate repositioning and/or replacing of signage, while mitigating or eliminating damage to the signage.

Various aspects described herein are directed to providing apparatuses (e.g., portable modular brackets) configured to wrap or close around a supporting structure (e.g., pole) such that the apparatuses are connected to supporting structures due in part to friction, elastic force, tension, and/or other forces, while allowing signage to be retained by the apparatuses (e.g., portable modular brackets) also due in part to friction, elastic force, tension, and/or other forces. The friction, elastic force, tension, and/or other forces created by the apparatuses may eliminate the need for secondary mounting supports and/or mechanical fasteners to hold the apparatuses to the supporting structures (e.g., poles).

The friction, elastic force, tension, and/or other forces may allow the apparatuses to be mounted in either a vertical or horizontal configuration. Some embodiments of apparatuses described herein may overcome the spatial constraints of conventional approaches to signage presentations in which signage is positioned directly on a tabletop or other surface—specifically, apparatuses of the present disclosure are positioned on supporting structures having some available space that might otherwise go unused, such as the approximate midsection of a pole. Illustratively, positioning an apparatus retaining signage on a pole, such as an umbrella pole or support pole for a space heater, may provide more surface space, e.g., on a tabletop for table settings, dishes, glasses, or other such items. Contemporaneously, the apparatuses described herein may respectively include at least one signage retention feature configured to retain signage via friction, elastic force, tension, and/or other forces effected by the apparatuses.

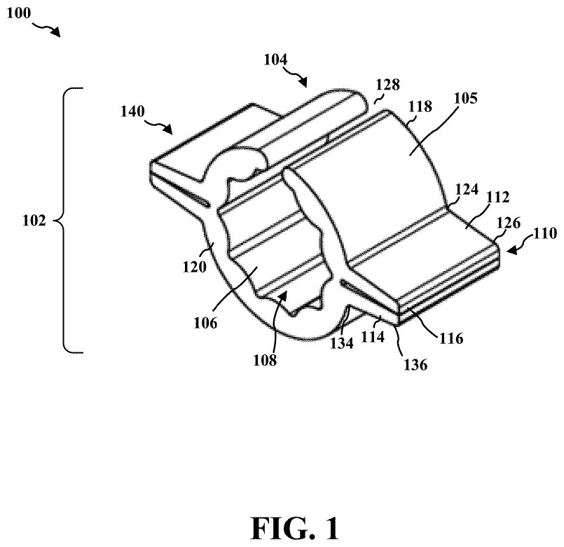

FIG. 1 is a perspective view 100 of an apparatus 102. The apparatus 102 includes a body 104 having an outer surface 105 and an inner surface 106. In some aspects, the outer surface 105 may be a “side” surface of the apparatus 102 (similarly, the inner surface 106 may also be a side surface, at least with respect to perspective of the apparatus 102). The apparatus 102 further includes at least one extension 110, which may be connected with the outer surface 105 of the body—e.g., the extension 110 may be molded or otherwise manufactured with the body 104. The extension 110 includes a first finger 112 and a second finger 114, with the fingers 112.

The geometry according to which the apparatus 102 is configured may define one or more spaces (e.g., empty spaces or negative spaces). Specifically, the body 104 defines, or is a boundary surrounding, a gap 108, e.g., by virtue of at least partially surrounding the gap 108. For example, the inner surface 106 at least partially circumscribes or encircles the gap 108, and therefore, the shape of the inner surface 106 defines the shape of the gap 108. As the body 104 may be open at both ends, the gap 108 may be lengthwise through the entire body 104 from one open end to the other open end.

In some aspects, the body 104 may be annular or substantially annular; that is, the body 104 may be circular or ring-shaped. Thus, at least one of the outer surface 105 and/or the inner surface 106 may be annular or substantially annular. For example, as viewed from an overhead or top-down perspective through the gap 108, the inner surface 106 may circularly traverse up to 360 degrees (°).

In some other aspects, however, the body 104 may include one or more right angles. For example, at least one of the outer surface 105 and/or the inner surface 106 may be substantially shaped like a square or a rectangle. In still other aspects, the outer surface 105 and the inner surface 106 may be differently shaped, with the geometry of the inner surface 106 affecting which shapes of support structures the apparatus 102 can be mounted.

According to various embodiments, the body 104 may be configured as a bracket or a collar—e.g., in the illustrated embodiment, the body 104 is a substantially cylindrical bracket or collar portion of the apparatus 102. The body 104 may be configured to connected with or engage a support structure, which may be positioned through the gap 108. Effectively, the apparatus 102 may be mounted on a support structure, and the apparatus 102 may receive the support structure through the gap 108.

In some embodiments, the apparatus 102 may receive a support structure through the gap 108 by being placed over one end of the support structure and moved into a desirable position. For example, a user may place the apparatus 102 over an end of a support structure (e.g., pole), with the user positioning the apparatus 102 such that the support structure is within the gap 108. The user may then move the apparatus 102 along the support structure (e.g., horizontally, vertically, diagonally, etc., depending upon the orientation of the support structure).

In some embodiments, the body 104 may be configured to form an opening 128 through to the gap 108. Illustratively, the opening 128 may be a slot or slit, which may extend across the body 104. For example, the opening 128 may be lengthwise, or the opening 128 may be from top to bottom of the body 104.

In forming the opening 128, the body 104 may be discontinuous such that a break provides an ingress from the exterior of the body 104 (e.g., the outer surface 105) through to the interior of the body 104 (e.g., the inner surface 106). According to some embodiments, then, the gap 108 is not entirely circumscribed by the body 104. Rather, the body 104 may form an opening 128 at which the outer surface 105 is unconnected, and similarly, the inner surface 106 is unconnected. The outer surface 105 and the inner surface 106 may connect with one another on either side of the opening 128.

The body 104 may include a first end 118 and a second end 120. It will be appreciated that the terminology of “end” does not impart any specific configurations, features, or orientations of the apparatus 102. Rather, “first end” and “second end” are intended to differentiate those portions (e.g., surfaces) of the apparatus 102 from other surfaces, faces, sections, sides, or other features of the apparatus 102. For example, the first end 118 may be the “top” of the apparatus 102 and the second end 120 may be the “bottom” or the apparatus 102, or vice versa. In another example, the first end 118 may be one “side” of the apparatus 102 and the second end 120 may be another (e.g., opposite) side of the apparatus 102.

The inner surface 106 and the outer surface 105 extend between the first and second ends 118, 120. The gap 108 may be located between the first and second ends 118, 120, and the opening 128 may likewise span the body 104 from the first end 118 to the second end 120. In forming the gap 108, the apparatus 102 may be configured to receive a support structure, e.g., through the opening 128.

For example, the body 104 may be semicircular such that the inner surface 106 (and potentially, the outer surface 105) circularly traverses less than 360 degrees (°)—e.g., at least the inner surface 106 may be inclusively between 300° and 350°. In other examples, the body 104 may include a plurality of angles, such as right angles, and so the body 104 may be rectangular (e.g., square-shaped). Thus, in order to form the opening 128, at least one side, or at least a portion thereof, may be absent from the body 104. The examples and embodiments described herein with respect to the geometry of the body 104 (as well as the outer and inner surfaces 105, 106) are intended to be illustrative, and other embodiments are possible without departing from the scope of the present disclosure.

As the discontinuity of the body 104 effects the opening 128 from the exterior of the body 104 through to the interior of the body 104, the outer surface 105 and the inner surface 106 may meet at either side of the opening 128. Accordingly, the outer surface 105 and the inner surface 106 may connect both sides of the opening 128, which may therefore form the opening 128 to the gap 108 at least partially circumscribed by the inner surface 106.

The opening 128 may facilitate the engagement of a support structure. By way of illustration, a support structure may include a pole, a post, a fence, or any structure suitable to support a relatively lighter weight apparatus that may at least partially wrap around the structure and apply a relatively nominal amount of pressure thereto.

A support structure may be received into the gap 108 through the opening 128.

The opening 128, however, may be appreciably more narrow than the width or diameter of a support structure to be received in the gap 108. Rather, the apparatus 102 may be configured to retain a support structure having a minimum width or minimum diameter that is approximately equal to the width or diameter of the gap 108, as defined by the width or diameter of the body 104 from the inner surface 106.

Therefore, the body 104 may be pliable or deformable to some degree such that the size of the opening 128 can be increased to accommodate a support structure received thereat and into the gap 108. For example, the body 104 may be configured with some amount of elasticity sufficient enough for the body 104 to increase the separation of the body 104 at the point of discontinuity. That is, one point at which the outer surface 105 and the inner surface 106 connect may be deformable away from the other point at which the outer surface 105 and the inner surface 106 connect.

In a practical context, a user of the apparatus 102 may pull the body 104 apart at the opening 128, e.g., by forcing one point at which the outer surface 105 and the inner surface 106 connect away from the other point at which the outer surface 105 and the inner surface 106 connect. In so doing, the opening 128 may be increased in size (e.g., width) and the user may position the apparatus 102 around a support structure by guiding the body 104 around the support structure so that the support structure passes through the opening 128 and is received into the gap 108.

The user may then release the body 104 or may push the body 104 together at the opening 128, e.g., by forcing one point at which the outer surface 105 and the inner surface 106 connect toward the other point at which the outer surface 105 and the inner surface 106 connect. Thus, the apparatus 102 may retain its position on the support structure, or the apparatus 102 may be mounted on the support structure.

In some embodiments, the apparatus 102 may be configured to retain its positioning or remain mounted on a support structure through tension, pressure, friction, and/or force (e.g., elastic force). For example, the apparatus 102 may be created or manufactured in a “default” state or configuration, which may be the state or configuration that the apparatus 102 is in when at rest, such as when no external forces (e.g., a user) are acting on the apparatus 102. By way of illustration, the apparatus 102 in FIG. 1 may be in the default state or configuration because no external forces are acting upon it.

In some embodiments, the apparatus 102 may be constructed of one or more suitable materials providing for a “memory” of the default state or configuration of the apparatus 102. In some additional or alternative embodiments, the apparatus 102 may be constructed of one or more materials having sufficient elasticity or elastic force to return to its default state or configuration. Thus, the body 104 may act to return to its default state or configuration if removed therefrom, e.g., due to external forces.

In addition, the apparatus 102 may have sufficient ductility and/or tensile strength to allow for the body 104 being pulled apart at the points at which the outer and inner surfaces 105, 106 connect without permanently deforming or breaking, e.g., at least until the size (e.g., width) of the opening 128 is increased to accommodate support structures having widths or diameters somewhat greater than the width or diameter of the gap 108 (as defined by the inner surface 106 of the body 104). As aforementioned, the apparatus 102 may then be positioned or mounted on a support structure, which may be received in the gap 108 through the opening 128 when the body 104 is deformed (e.g., pulled apart where the body 104 is discontinuous).

According to various embodiments, the body 104 may be composed of one or more materials having memory, elasticity, and/or elastic force, and therefore, the body 104 may return to its default state or configuration once the external force(s) are removed (e.g., once the body 104 is no longer being pulled apart at the points at which the outer and inner surfaces 105, 106 connect). The apparatus 102 may then retain or be mounted on a support structure that is positioned within the gap 108 when the external force(s) are removed and the body 104 returns to its default state or configuration.

If the support structure is of sufficient size (e.g., a width or diameter approximately equal to or greater than that of the gap 108), then the body 104 may retain its mounted position, such as the position of the apparatus 102 on the support structure. The body 104 may exert pressure or tension, e.g., inwardly onto the support structure. For example, the memory, elasticity, and/or elastic force of the apparatus 102 may inherently drive the body 104 toward its default state or configuration. Thus, a support structure that is wider (or has a greater diameter) than the gap 108 may be a perpetual external force that acts to apply force outwardly. Conversely, the body 104 may perpetually apply an inward force on the support structure, as the body 104 attempts to return to its default state or configuration.

The forces between the outward pressure applied by the support structure and the inward pressure applied by the body 104 may result in friction (e.g., static friction). The apparatus 102 may retain its position on the support structure, or may remain mounted on the support structure, due to the friction resulting from the diametrically opposing inward and outward pressures between the body 104 and the support structure, respectively. For example, the static coefficient of friction between the body 104 (as effected at the inner surface 106) and the support structure may be sufficient to counteract gravitational pull so that the apparatus 102 is retained or mounted on the support structure, e.g., so that the apparatus 102 remains substantially in position on the support structure.

According to various embodiments, the apparatus 102 further comprises at least one extension 110 extending from the outer surface 105 of the body 104. For example, the at least one extension 110 may be perpendicular, or approximately perpendicular, to the outer surface 105 and the inner surface 106. In some further embodiments, the apparatus 102 may include multiple extensions, such as the second extension 140. The second extension 140 may be configured substantially the same as the at least one extension 110; however, the second extension 140 may be configured on a different location of the apparatus 102, e.g., the second extension 140 may be configured on an opposite surface of the at least one extension 110 (e.g., the second extension 140 may be 180° from the at least one extension 110).

In some embodiments, the at least one extension 110 may extend lengthwise across the outer surface 105 of the body 104—that is, the at least one extension 110 may extend from the first end 118 to the second end 120. In some other embodiments, however, the at least one extension 110 may be less than the width (or height) of the outer surface 105 of the body 104, e.g., so that the at least one extension 110 does not extend from the first end 118 to the second end 120.

In some aspects, the at least one extension 110 may be a signage retention feature—that is, the at least one extension 110 may be a feature of the apparatus 102 configured to retain signage such that the signage is presented or displayed by the apparatus 102 while remaining in a substantially fixed position.

The at least one extension 110 may be molded or fabricated with the body 104, e.g., so that the apparatus 102 is a unibody apparatus. For example, the apparatus 102, including the body 104 and at least one extension 110, may be formed as a single solid piece via injection molding or other known technique. In some other embodiments, the at least one extension 110 may be separately attached or connected with the body 104, e.g., via welding, adhesive(s), or other fabrication technique.

The at least one extension 110 may include a first finger 112 and a second finger 114, which may also be referred to as “protrusions” or other similar term. While the first and second fingers 112, 114 may be described in some embodiments as elements of one “extension” (e.g., the extension 110), the first and second fingers 112, 114 may be regarded as separate and/or individual elements in some other embodiments.

By way of illustrating the orientation and configuration of the apparatus 102, each of the first and second fingers 112, 114 may include a respective proximal end 124, 134 and a respective distal end 126, 136. The proximal ends 124, 134 may be the ends of the first and second fingers 112, 114 closest to the body 104, whereas the distal ends 126, 136 may be the ends of the first and second fingers 112, 114 furthest from the body 104. For example, the first and second fingers 112, 114 may be molded, fabricated, or otherwise affixed to the body 104 at the respective proximal ends 124, 134.

The first and second fingers 112, 114 may be at least partially separated by a groove 116. The groove 116 may also be referred to as a slot, slit, or other similar term. In some embodiments, the first and second fingers 112, 114 may not contact one another—e.g., the groove 116 may separate the first and second fingers 112, 114 from the proximal ends 124, 134 up through the distal ends 126, 136. In some other embodiments, the groove 116 may separate the first and second fingers 112, 114 from the proximal ends 124, 134, but the first and second fingers 112, 114 may contact one another at the distal ends 126, 136.

For example, the first finger 112 may be configured to angle toward the second finger 114, e.g., such that the distance between the distal end 126 of the first finger 112 and the distal end 136 of the second finger 114 is less than the distance between the proximal end 124 of first finger 112 and the proximal end 134 of the second finger 114. Potentially, the distal end 126 of the first finger 112 is in contact with the distal end 136 of the second finger 114.

The at least one extension 110 may be configured to engage and retain signage. Examples of signage include paper products, laminated products, plastic products, cardboard products, wood products, and/or substantially any other material suitable to be received between the first and second fingers 112, 114, and retained in place due to the friction caused by the first and second fingers 112, 114. Illustratively, signage may include advertisements, marketing materials, menus, informational notices, pamphlets, and/or substantially any text or graphics suitable to be conveyed on a print medium.

In some embodiments, the at least one extension 110 may be configured to retain signage through tension, pressure, friction, and/or force (e.g., elastic force). For example, the at least one extension 110 may be created or manufactured with a “default” state or configuration, which may be the state or configuration that the at least one extension 110 is in when at rest, such as when no external forces (e.g., a user) are acting on the at least one extension 110. By way of illustration, the at least one extension 110 in FIG. 1 may be in the default state or configuration because no external forces are acting upon it.

According to some aspects, at least one of the first and/or second fingers 112, 114 may be deformable, e.g., in a direction opposite of the other one of the first or second fingers 112. Such deformation may increase the separation between the first and second fingers 112, 114, effectively increasing the size of the groove 116.

However, the at least one extension 110 may be constructed of one or more suitable materials providing for a “memory” of the default state or configuration of the at least one extension 110. In some additional or alternative embodiments, the at least one extension 110 may be constructed of one or more materials having sufficient elasticity or elastic force to return to its default state or configuration. Thus, the at least one extension 110 may act to return to its default state or configuration if removed therefrom, e.g., due to external forces.

In addition, the at least one extension 110 may have sufficient ductility and/or tensile strength to allow for the first and/or second fingers 112, 114 being pulled apart or deformed relatively closer to the distal ends 126, 136 rather than the proximal ends 124, 134 without permanently deforming or breaking, e.g., at least until the size (e.g., width) of the groove 116 is increased to accommodate signage having widths somewhat greater than the width of the groove 116. The at least one extension 110 may then have a signage placed between the first and second fingers 112, 114, which may be received in the groove 116 (e.g., when the first and/or second fingers 112, 114 are being deformed or pulled/pushed apart).

According to various embodiments, the at least one extension 110 may be composed of one or more materials having memory, elasticity, and/or elastic force, and therefore, the at least one extension 110 may return to its default state or configuration once the external force(s) are removed (e.g., once the first and/or second fingers 112, 114 is/are no longer being pulled or pushed apart. The at least one extension 110 may then retain signage that is positioned within the groove 116 when the external force(s) are removed and the at least one extension 110 returns to its default state or configuration.

If the signage is of sufficient size (e.g., a width approximately equal to or greater than that of the groove 116 at the distal ends 126, 136), then the at least one extension 110 may retain signage therein. The first and/or second fingers 112, 114 may exert pressure or tension, e.g., inwardly onto the signage. For example, the memory, elasticity, and/or elastic force of the first and/or second fingers 112, 114 may inherently drive the at least one extension 110 toward its default state or configuration. Thus, signage that is wider than the groove 116 may be a perpetual external force that acts to apply force outwardly. Conversely, the first and/or second fingers 112, 114 may perpetually apply an inward force on the signage, as the at least one extension 110 attempts to return to its default state or configuration.

The forces between the outward pressure applied by the signage and the inward pressure applied by the first and/or second fingers 112, 114 may result in friction (e.g., static friction). The at least one extension 110 may retain signage at least partially within the groove 116, e.g., due to the friction resulting from the diametrically opposing inward and outward pressures between the first and/or second fingers 112, 114 and the signage, respectively.

In some other embodiments, the first finger 112 may exert force toward the second finger 114 and/or the second finger 114 may exert force toward the first finger 112. Potentially, the first finger 112 may be configured to apply pressure towards and/or onto the second finger 114 and/or the second finger 114 may apply pressure towards and/or onto the first finger 112. For example, the distal end 126 of the first finger 112 may be configured to contact the distal end 136 of the second finger 114 (e.g., according to a default state or configuration of the at least one extension).

The first finger 112 may be configured to be angled toward the second finger 114, and the angle (e.g., on the surface of the first finger 112 facing the second finger 114 with respect to the outer surface 105) may be sufficiently acute such that the distal end 126 of the first finger 112 is forced or pressed into the distal end 136 of the second finger 114. Additionally or alternatively, the second finger 114 may be configured to be angled toward the first finger 112, and the angle (e.g., on the surface of the second finger 114 facing the first finger 112 with respect to the outer surface 105) may be sufficiently acute such that the distal end 136 of the second finger 114 is forced or pressed into the distal end 126 of the first finger 112.

Accordingly, the first and second fingers 112, 114 may be configured to exert opposing forces on signage positioned therebetween. For example, the first finger 112 may be configured to exert force in a first direction, whereas the second finger 114 may be configured to exert force in a second direction, and the second direction may be approximately opposite to (e.g., approximately 180° from) the first direction. The forces exerted by the first and second fingers 112, 114 may be applied at the respective distal ends 126, 136. Thus, the distal end 126 of the first finger 112 may exert force in the direction toward the proximal end 134 of the second finger 114, and/or the distal end 136 of the second finger 114 may exert force in the direction toward the proximal end 124 of the first finger 112.

As described herein, the force(s) and/or pressure(s) applied by the first and/or second fingers 112, 114 may be sufficient to retain signage therebetween. In particular, the friction between signage and at least one of the first and/or second fingers 112, 114 may be sufficient to counteract other force(s) acting on the signage so that the signage is retained in place between the first and second fingers 112, 114. For example, the static coefficient of friction between the signage and at least one of the first and/or second fingers 112, 114 may be sufficient to counteract gravitational pull so that the signage is retained between the first and second fingers 112, 114.

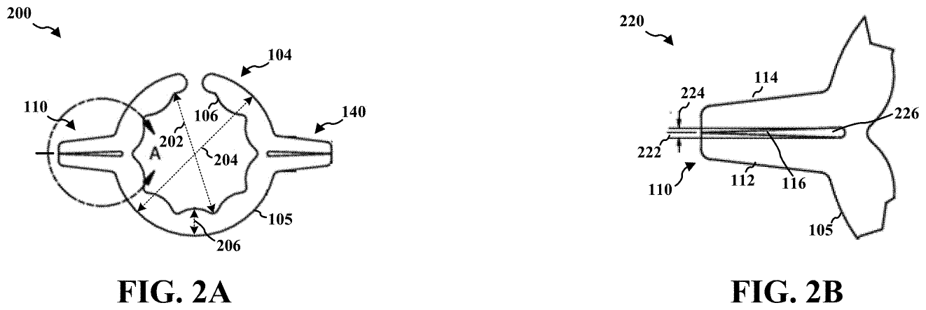

FIG. 2A illustrates an overhead perspective 200 of the apparatus 102 of FIG. 1. In some aspects, as shown in FIG. 2A, the body 104 of the apparatus 102 may be cylindrically shaped. However, the bracket may be configured in many different configurations, and is not intended to be limited to the aspects disclosed herein. The body 104 may comprise an inner diameter 202 about the inner surface 106, and an outer diameter 204 about the outer surface 105.

The inner and/or outer diameters 202, 204, as well as a distance 206 therebetween (e.g., a distance between the outer and inner surfaces 105, 106) may vary according to different embodiments. Furthermore, a distance 206 between the outer and inner surfaces 105, 106 (e.g., a distance between the inner and outer diameters 202, 204), which may also be referred to as a “thickness,” may vary according to different embodiments. For example, the inner and/or outer diameters 202, 204 may be relatively greater to accommodate relatively larger support structures. Similarly, the inner-to-outer surface distance 206 may be relatively greater to accommodate relatively larger support structures, e.g., as the increased thickness may increase the strength of the body 104 and facilitate greater amounts of deformation of the body 104 so that the body 104 may be positioned around a support structure.

By way of illustration, the inner diameter 202 may be inclusively between one (1) inch and six (6) inches, the outer diameter 204 may be inclusively between 1.2 inches and 6.2 inches, and/or the inner-to-outer surface distance 206 may be inclusively between 0.2 inches and 2.5 inches. It will be appreciated that the foregoing examples are not intended to be limiting, and other configurations (e.g., of measurements) are within the scope of this disclosure.

As illustrated in FIG. 2A, the at least one extension 110 may be deformable, e.g., approximately along the arc A. In particular, the first finger 112 may be deformable away from the second finger 114 and back toward the outer surface 105 of the body 104, e.g., approximately along the arc A. Similarly, the second finger 114 may be deformable away from the first finger 112 and back toward the outer surface 105 of the body 104, e.g., approximately along the arc A.

In order for one of the fingers to be deformed, a force or pressure must be applied to the finger, such as when a user pulls or wedges at least one finger apart. However, the first finger 112 and/or the second finger 114 may be configured with a memory, default state/configuration, and/or elasticity, and therefore, the first finger 112 and/or the second finger 114 may return to a respective original position or default state/configuration, e.g., along the arc A. For example, when one of the fingers is deformed, that one of the fingers may exert a force (e.g., an elastic force) to return to its original position or default state/configuration, which may be in the direction of the other one of the fingers.

FIG. 2B illustrates an overhead perspective 220 of a portion of the apparatus 102 of FIG. 1. Specifically, the overhead perspective 220 shows the at least one extension 110. As illustrated, the at least one extension 110 exerts force(s) 224 (and/or applies pressure(s)) on to signage 222. The force(s) 224 may increase friction (e.g., a static coefficient of friction) so that the signage 222 is retained between the fingers 112, 114 of the at least one extension 110.

In some embodiments, the at least one extension 110 is configured to form an aperture 226, which may be part of or connected with the groove 116. For example, the aperture 226 may be formed by the proximal ends 124, 134ds of the fingers 112, 114. In some aspects, the aperture 226 may be formed by virtue of the proximal ends 124, 134 being separated by a greater amount of space than the distal ends 126, 136 of the fingers 112, 114.

The aperture 226 may be a space (e.g., an open space or a negative space) between the first and second fingers 112, 114, e.g., at least near or at the proximal ends 124, 134. The aperture 226 may be wider than the groove 116. The aperture 226 may facilitate engagement of the signage 222—that is, the signage 222 may be received into the at least one extension 110 through the aperture 226. For example, as the first and/or second fingers 112, 114 may exert force(s) toward one another, inserting the signage 222 between the first and second fingers 112, 114 may be relatively difficult.

The aperture 226 may facilitate insertion of the signage 222 between the fingers, e.g., as the signage 222 may be initially inserted into the aperture 226, and then slid into a desirable position between the first and second fingers 112, 114. In some embodiments, then, the signage 222 may be used to wedge the first and second fingers 112, 114 apart—e.g., such that the first and/or second fingers 112, 114 is/are deformed (although such deformation may be relatively minor and potentially imperceptible). The size (e.g., width, length), shape, transition or end, and/or other characteristics of the aperture 226 may vary according to different embodiments; potentially, such characteristics of the aperture 226 may be based on the signage intended to be retained between the first and second fingers 112, 114.

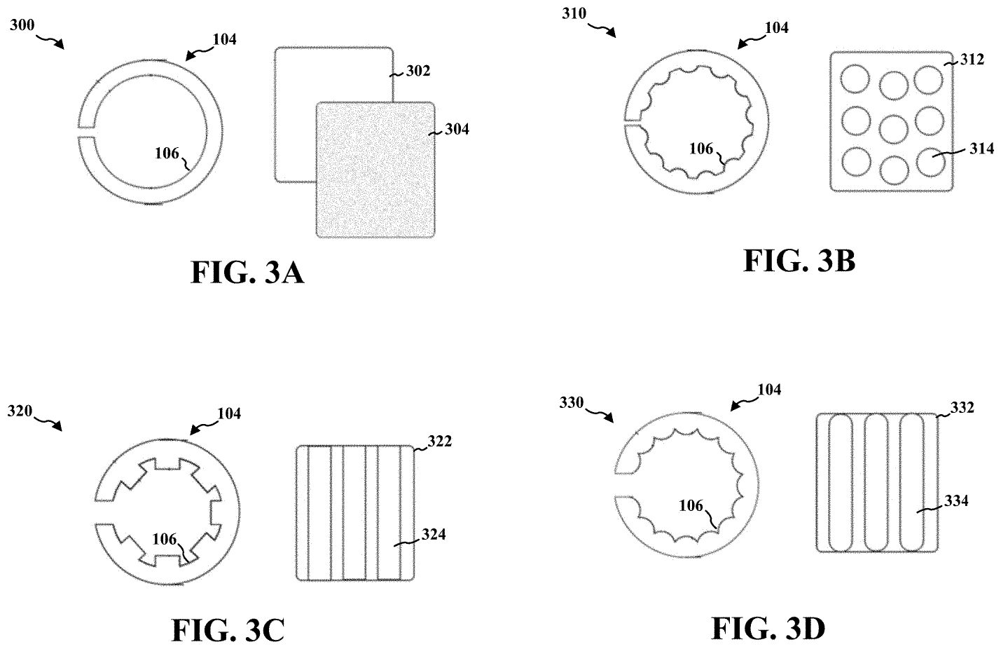

Referring to FIGS. 3A through 3D, various embodiments of the inner surface 106 of the body 104 of the apparatus 102 are shown. As shown in FIGS. 3A-3D, the body 104 may include a plurality of inner and/or outer surfaces such that the inner and/or outer surfaces may or may not correspond to a respective diameter. However, in some aspects, the plurality of inner and/or outer surfaces may generally correspond to a respective diameter.

The apparatus 102 may be removably coupled to a structure or pole due to the gap 108. The inner surface may be arrange to have an inner diameter 202 that is less than a diameter of the structure or pole. As such, when the apparatus 102 is received by the structure or pole, the pole may cause the apparatus 102 to exert a compression or tension force onto the structure or pole in order to couple or mount the apparatus 102 to the structure or pole. The inner surfaces 106 of the apparatus 102 may include textured surfaces, as shown in FIG. 3. In some aspects, the inner surfaces may also include raised surfaces, peaks and valleys, or the like to assist in holding the bracket to the structure or pole. In some aspects, the peaks and valleys of the inner surfaces may allow for inconsistences on the pole structure that limit the grip ability of the bracket. These peak and valleys may include flat and/or rounded surfaces that may provide multiple grip touch points to assist in mounting the bracket to the pole. Having multiple grip touch points allows the bracket to be adaptable to unknown variables that are on the pole or structure it will be mounted onto, such as damage to a pole, irregular surfaces, slick or rough surfaces that need the bracket to adapt to these unknown pole surfaces.

When the apparatus 102 is coupled to the structure or pole, the compression or tension force of the bracket may cause the groove 116 of the at least one extension 110 to substantially close, such that compression or tension force causes the first and second fingers 112, 114 of the at least one extension 110 to be moved towards the opposing finger, thereby closing the groove, as shown in FIG. 2. This force is exerted onto the first and second fingers in response to the bracket being wrapped around and mounted onto the pole. Since the pole has an outer diameter greater than the inner diameter of the bracket, the bracket experiences a resistive force or compression force when mounted onto the pole. This resistive force or compression force is thereby transferred to the first and second fingers of the at least one extension, which causes the first and second fingers to apply a force onto the opposing finger. The force exerted by the first and second fingers allows the at least one extension to hold advertising or marketing material within the groove 116, such as but not limited to printed paper or the like. The force exerted by the first and second fingers 112, 114 is sufficient to compress and hold the advertising or marketing material within the groove 116. In some aspects, the apparatus 102 may be configured to exert a force at least onto the at least one extension. The exerted force may be configured to substantially close the groove 116 such that the first and second finger 112, 114 are displaced in a direction towards each other.

With respect to FIG. 3A, an overhead perspective 300 of the body 104 is illustrated. At least a portion of the inner surface 106 of the body 104 may include, for example, a smooth surface 302 and/or a textured surface 304. For example, the textured surface 304 may include stippling or an abrasive surface. For example, the textured surface 304 may include an abrasive coating.

FIG. 3B illustrates an overhead perspective 310 of the body 104. At least a portion of the inner surface 106 of the body may include a contoured surface 312. The contoured surface 312 may include a plurality of raised bumps 314, which may be circular or semi-circular. For example, the raised bumps 314 may be shaped as bubbles. The raised bumps 314 may be arranged in lines both horizontally and vertically.

FIG. 3C illustrates an overhead perspective 320 of the body 104. At least a portion of the inner surface 106 of the body may include a inclined surface 322. The inclined surface 322 may include a plurality of inclines 324, which may be substantially rectangular. That is, each of the inclines 324 may protrude from the inner surface 106 and each of the inclines 324 may be substantially flat or smooth across the sides (e.g., including the “top” or innermost side). In some embodiments, each of the inclines 324 may extend across the inner surface 106 from the first end 118 to the second end 120.

FIG. 3D illustrates an overhead perspective 330 of the body 104. At least a portion of the inner surface 106 of the body may include a rounded surface 332. The rounded surface 332 may include a plurality of cylindrical surfaces 334, which may be arranged as slopes. That is, each of the cylindrical surfaces 334 may protrude from the inner surface 106 and each of the cylindrical surfaces 334 may be substantially rounded or semi-circular. In some embodiments, each of the cylindrical surfaces 334 may extend across the inner surface 106 from the first end 118 to the second end 120.

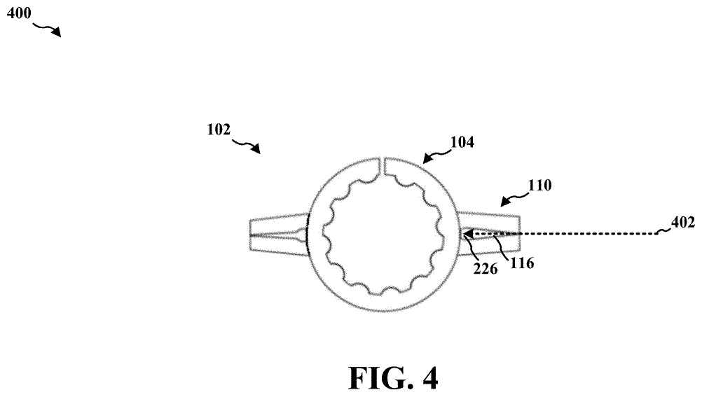

Referring to FIG. 4, an overhead perspective 400 of the apparatus 102 is illustrated. As shown in FIG. 4, a signage may be inserted into the groove 116 formed by the at least one extension 110. Specifically, the signage may be follow an insertion 402 in which the signage is inserted into the aperture 226.

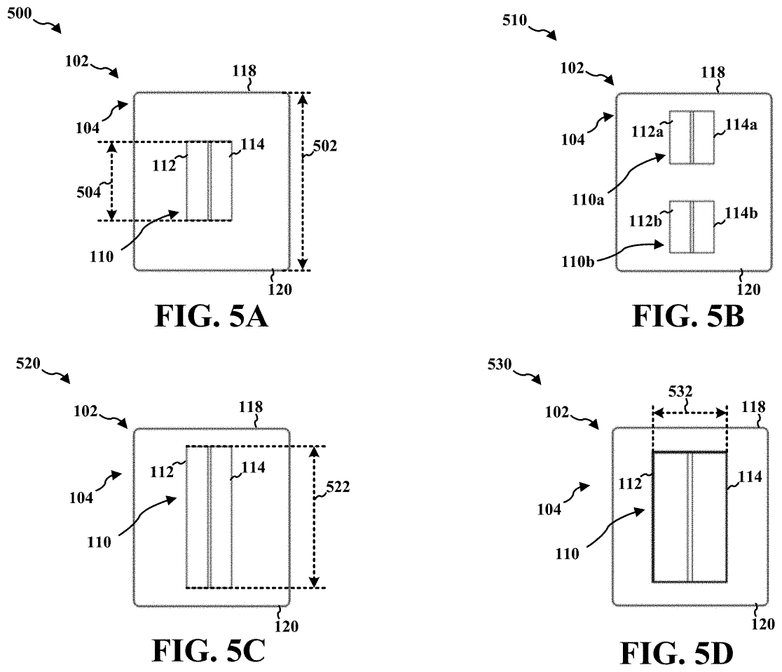

FIGS. 5A through 5D are side perspectives of various embodiments of the apparatus 102. The apparatus 102 includes a characteristic of the distance between the first end 118 and the second end, which may also be referred to as “height” 502. Illustratively, the height 502 may be inclusively between 0.1 inches and eight (8) inches. According to some illustrative configurations, the at least one extension 110 may have a height approximately equal to or slightly less than (e.g., 0.05 inches to 0.2 inches) less than the height 502 of the body 104. However, other dimensions of the height 502 of the body 104 and/or the height of the at least one extension 110 are possible without departing from the scope of the present disclosure.

In FIG. 5A, a side perspective 500 illustrates an embodiment of the apparatus 102 in which the at least one extension 110 is positioned on a side of the body 104. The at least one extension 110 may not extend from the first end 118 to the second end 120.

In the illustrated side perspective 500, the at least one extension 110 may have a characteristic of height 504. The height 504 may be the distance from the “bottom” of the proximal ends 124, 134 to the “top” of the proximal ends 124, 134, e.g., the bottom of the proximal ends 124, 134 may be the side(s) of the proximal ends 124, 134 relatively closest to the second end 120 of the body 104, whereas the top of the proximal ends 124, 134 may be the side(s) of the proximal ends 124, 134 relatively closest to the first end 118 of the body 104. In the embodiment illustrated in FIG. 5A, the height 504 of the at least one extension 110 may be inclusively between ½ (0.5) inches and four (4) inches. For example, the height 502 of the at least one extension 110 may be approximately ½ (0.5) times the height 502 of the body 104. However, other dimensions of the height 504 of the at least one extension 110 are possible without departing from the scope of the present disclosure.

In FIG. 5B, a side perspective 510 illustrates an embodiment of the apparatus 102 in which the at least two extensions 110a-b are positioned on a side of the body 104. The extensions 110a-b may be arranged such that one extension 110a is atop or above the other extension 110b; that is, one extension 110a may be relatively closer to the first end 118, whereas the other extension 110b may be relatively closer to the second end 120. Each of the extensions 110a-b may include a respective first finger 112a or 112b and a respective second finger 114a or 114b.

In FIG. 5C, a side perspective 520 illustrates an embodiment of the apparatus 102 in which the at least one extension 110 is positioned on a side of the body 104 and extends from or nearly from the first end 118 to the second end 120.

In the illustrated side perspective 520, the at least one extension 110 may have a characteristic of height 522, which may be larger than that of the embodiment illustrated in FIG. 5A. For example, in the embodiment illustrated in FIG. 5C, the height 522 of the at least one extension 110 may be inclusively between one (1) inch and seven (7) inches. However, other dimensions of the height 504 of the at least one extension 110 are possible without departing from the scope of the present disclosure.

In FIG. 5D, a side perspective 530 illustrates an embodiment of the apparatus 102 in which the at least one extension 110 is positioned on a side of the body 104 and is relatively wider. For example, the relatively wider at least one extension may accommodate thicker signage.

In the illustrated side perspective 530, the at least one extension 110 may have a characteristic of width 532. The width 532 may be the distance from the outside edge of the proximal end 124 of the first finger 112 to the outside edge of the proximal end 134 of the second finger 114, e.g., with the “outside edge” referring to the edge of a proximal end being relatively furthest from the groove 116. In the embodiment illustrated in FIG. 5D, the width 532 of the at least one extension 110 may be inclusively between one (1) inch and six (6) inches. In some other embodiments, such as embodiments having a relatively more narrower extension (e.g., one or more of the embodiments illustrated by FIGS. 5A, 5B, and/or 5C), the width of the at least one extension 110 may be inclusively between approximately ½ (0.5) inches and four (4) inches. However, other dimensions of the width of the at least one extension 110 are possible without departing from the scope of the present disclosure.

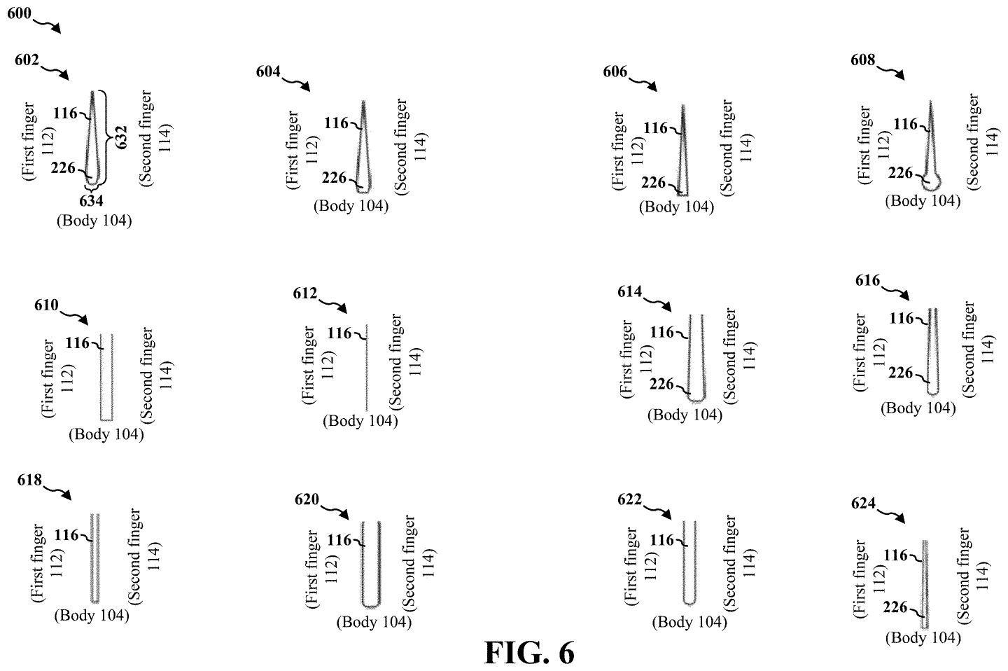

FIG. 6 is a diagram 600 illustrating various top perspectives of embodiments of the groove 116 disposed between the first and second fingers 112, 114 of the at least one extension 110. According to various embodiments, the fingers 112, 114 may be deformable away from the groove 116, and therefore, the at least one extension 110 may be configured such that the width of the groove 116 may be increased. FIG. 6 may illustrate various embodiments of the groove 116 when the fingers 112, 114 are in a default state/configuration in which no external forces are acting to deform or separate the fingers 112, 114, as when signage is being positioned between the fingers 112, 114 for retention by the at least one extension 110.

The embodiments of the groove 116 implemented may be based upon the signage intended to be retained by the at least one extension 110. For example, the shape, width, length, and/or depth of the groove 116 formed by the at least one extension may be based on the thickness and/or weight of the signage intended to be retained by the at least one extension 110.

As illustrated by the first top perspective 602, some embodiments of the apparatus 102 may include a groove 116 that is tapered. The groove 116 may taper to the narrowest point at the point relatively closest to the distal ends 126, 136 of the first and second fingers 112, 114. Accordingly, the groove 116 may be widest at the point relatively closest to the proximal ends 124, 134 of the first and second fingers 112, 114. This widest point of the tapering may form the aperture 226. The aperture 226 may be rounded at the point relatively closest to the proximal ends 124, 134 of the first and second fingers 112, 114.

As illustrated by the first top perspective 602, some embodiments of the apparatus 102 may include a groove 116 that is tapered. The groove 116 may taper to the narrowest point at the point relatively closest to the distal ends 126, 136 of the first and second fingers 112, 114. Accordingly, the groove 116 may be widest at the point relatively closest to the proximal ends 124, 134 of the first and second fingers 112, 114. This widest point of the tapering may form the aperture 226. The aperture 226 may be rounded at the point relatively closest to the proximal ends 124, 134 of the first and second fingers 112, 114.

In the illustrated side perspective 520, the at least one extension 110 may have a characteristic of length 632. The length 632 may be the distance from the point of the groove 116 relatively closest to the proximal ends 124, 134 of the first and second fingers 112, 114 to the point of the groove 116 relatively closest to the distal ends 126, 136 of the first and second fingers 112, 114. In some embodiments, the point of the groove 116 relatively closest to the proximal ends 124, 134 of the first and second fingers 112, 114 may include the aperture 226. In the embodiment illustrated by the top perspective 602, the length 632 of the groove 116 may be inclusively between 0.1 inches and five (5) inches. However, other dimensions of the width of the at least one extension 110 are possible without departing from the scope of the present disclosure.

According to some embodiments of the illustrated top perspective 602, the groove 116 may have a characteristic of width 634. The width 634 may be the distance from the inner surface of the first finger 112 (e.g., the inner surface may be the surface of the finger closest to the groove) to the inner surface of the second finger 114. In some embodiments, the width 634 may vary along the groove 116, e.g., with the widest point of the groove 116 being relatively closest to the body 104 and the narrowest point of the groove 116 being relatively furthest from the body 104. In the embodiment illustrated by the top perspective 602, the width 634 of the groove 116 may be inclusively between zero (0) inches and one (1) inch—e.g., the width 634 may be zero at the point at which the first finger 112 is in contact with the second finger 114. The width 634 may vary as of the groove tapers, with the widest section of the groove 116 being at the aperture 226. Other dimensions of the width 634 of the groove 116 are possible without departing from the scope of the present disclosure.

As illustrated in other perspectives shown in FIG. 6, the lengths 632 and/or widths 634 of the groove 116 may be different in different embodiments. For example, in some embodiments, the groove 116 may be tapered, whereas in other embodiments, the groove 116 may have a relatively uniform width. Additionally, in some embodiments, the at least one extension 110 may be configured to form the groove 116 with a relatively wider portion at a point relatively closest to the body 104, which may be the aperture 226. However, other embodiments of the groove 116, the at least one extension 110 may be configured such that the aperture 226 is absent; that is, the at least one extension 110 may form a groove 116 but may not form an aperture 226.

As illustrated by the second top perspective 604, some embodiments of the apparatus 102 may include at least one extension 110 that is configured to form a groove 116 that may taper to the narrowest point at the point relatively closest to the distal ends 126, 136 of the first and second fingers 112, 114. As aforementioned, the widest point of the tapering may form the aperture 226. In the embodiment shown by the second top perspective 604, the aperture 226 may be relatively flat at the point relatively closest to the proximal ends 124, 134 of the first and second fingers 112, 114, but the first and second fingers 112, 114 may form some rounding of the aperture 226 as the groove 116 transitions into the taper.

According to the third top perspective 606, some embodiments of the apparatus 102 may include at least one extension 110 that is configured to form a groove 116 that may taper to the narrowest point at the point relatively closest to the distal ends 126, 136 of the first and second fingers 112, 114. In the embodiment shown by the third top perspective 606, the groove 116 may be relatively triangular, with the base of the triangle forming the aperture 226. The first and second fingers 112, 114 may be in contact at respective distal ends 126, 136.

Referring to the fourth top perspective 608, some embodiments of the apparatus 102 may include at least one extension 110 that is configured to form a groove 116 that may taper to the narrowest point at the point relatively closest to the distal ends 126, 136 of the first and second fingers 112, 114. In the embodiment shown by the fourth top perspective 608, the at least one extension 110 may form a groove 116 having an aperture 226 that is relatively wider than the rest of the groove 116. For example, the at least one extension 110 may form an aperture 226 that is formed as a bulb at the base—that is, the aperture 226 may be substantially circular or annular.

According to the fifth top perspective 610, some embodiments of the apparatus 102 may include at least one extension 110 that is configured to form a groove 116 having a relatively uniform width. The groove 116 may have a substantially uniform non-zero width, which may be formed as the first and second fingers 112, 114 do not contact one another and are approximately the same distance from one another from respective proximal ends 124, 134 to respective distal ends 126, 136.

As shown by the sixth top perspective 612, some embodiments of the apparatus 102 may include at least one extension 110 that is configured to form a groove 116 having a relatively uniform width, although that uniform width may be substantially zero. The groove 116 may have a substantially uniform zero width as a result of the first and second fingers 112, 114 contacting one another from respective proximal ends 124, 134 to respective distal ends 126, 136.

Referring to the seventh top perspective 614, some embodiments of the apparatus 102 may include at least one extension 110 that is configured to form a groove 116 that may taper to the narrowest point at the point relatively closest to the distal ends 126, 136 of the first and second fingers 112, 114. In the embodiment shown by the seventh top perspective 614, however, the at least one extension 110 may form a groove 116 having a non-zero width along the entire groove. In other words, the first and second fingers 112, 114 may not contact one another along the entire length of the groove 116. The at least one extension may form an aperture 226 having a rounded base (closest to the body 104).

Referring to the eighth top perspective 616, some embodiments of the apparatus 102 may include at least one extension 110 that is configured to form a groove 116 that may taper to the narrowest point at the point relatively closest to the distal ends 126, 136 of the first and second fingers 112, 114. The embodiments shown by the eighth top perspective 616 may be similar to that shown by the seventh top perspective 614; however, the at least one extension 110 may form a groove 116 relatively narrower and/or tapering with a relatively greater angle in the embodiments of the eighth top perspective 616 relative to embodiments of the seventh top perspective 614.

According to the ninth top perspective 618, some embodiments of the apparatus 102 may include at least one extension 110 that is configured to form a groove 116 having a relatively uniform width. The groove 116 may have a substantially uniform non-zero width, which may be formed as the first and second fingers 112, 114 do not contact one another and are approximately the same distance from one another from respective proximal ends 124, 134 to respective distal ends 126, 136. The embodiments shown by the ninth top perspective 618 may be similar to that shown by the fifth top perspective 610; however, the at least one extension 110 may form a groove 116 relatively narrower in the embodiments of the ninth top perspective 618 relative to embodiments of the fifth top perspective 610.

According to the tenth top perspective 620, some embodiments of the apparatus 102 may include at least one extension 110 that is configured to form a groove 116 having a relatively non-zero uniform width, as the first and second fingers 112, 114 do not contact one another and are approximately the same distance from one another from respective proximal ends 124, 134 to respective distal ends 126, 136. The embodiments shown by the tenth top perspective 620 may include a base that is relatively rounded, which may facilitate reception of signage into the groove 116 (e.g., as a user may be able to slide the signage in against the rounded base of the groove 116 that is closest to the body 104).

According to the eleventh top perspective 622, some embodiments of the apparatus 102 may include at least one extension 110 that is configured to form a groove 116 having a relatively non-zero uniform width, as the first and second fingers 112, 114 do not contact one another and are approximately the same distance from one another from respective proximal ends 124, 134 to respective distal ends 126, 136. The embodiments shown by the eleventh top perspective 622 may include a base that is relatively rounded. The embodiments shown by the eleventh top perspective 622 may be similar to that shown by the tenth top perspective 620; however, the at least one extension 110 may form a groove 116 relatively narrower in the embodiments of the eleventh top perspective 622 relative to embodiments of the tenth top perspective 620.

According to the twelfth top perspective 624, some embodiments of the apparatus 102 may include at least one extension 110 that is configured to form a groove 116 that may taper to the narrowest point at the point relatively closest to the distal ends 126, 136 of the first and second fingers 112, 114. In the embodiment shown by the third top perspective 606, the groove 116 may be relatively triangular, with the base of the triangle forming the aperture 226. However, the first and second fingers 112, 114 may not be in contact at respective distal ends 126, 136. Thus, the width of the groove in embodiments shown by the twelfth top perspective 624 may be non-zero at all points, regardless of the angle at which the fingers 112, 114 to form the groove 116.

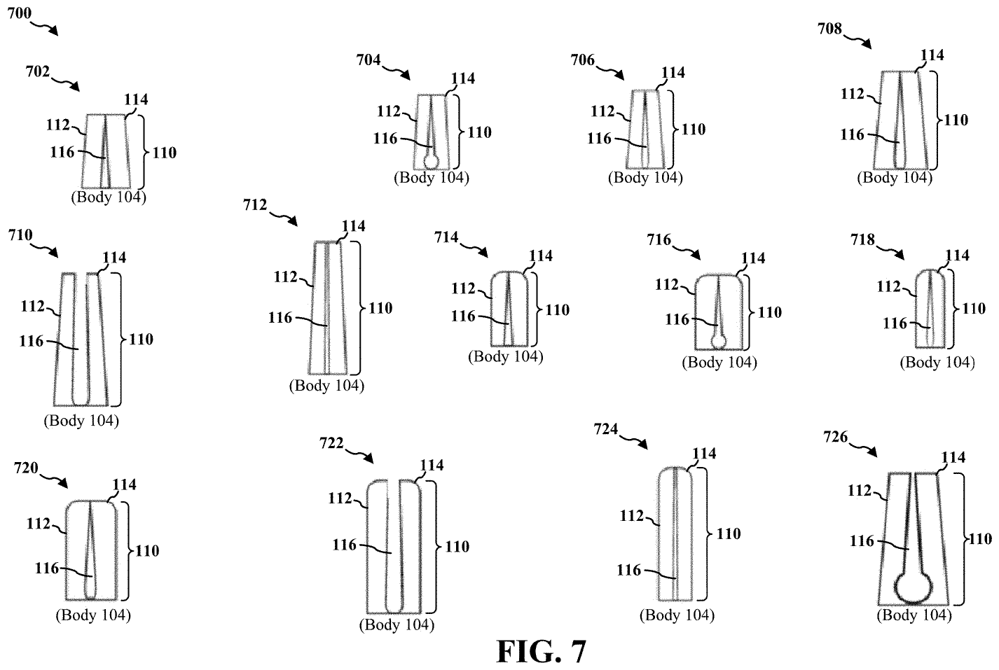

FIG. 7 is a diagram 700 illustrating various top perspectives of embodiments of the at least one extension 110 connected with a body 104. According to some embodiments shown in FIG. 7, the fingers 112, 114 may be deformable away from the groove 116, and therefore, the at least one extension 110 may be configured such that the width of the groove 116 may be increased. In some other embodiments, the fingers 112, 114 may be rigid, and therefore, non-deformable. FIG. 7 may illustrate various embodiments of the at least one extension 110 when the fingers 112, 114 are in a default state/configuration in which no external forces are acting to deform or separate the fingers 112, 114, as when signage is being positioned between the fingers 112, 114 for retention by the at least one extension 110.

The embodiments of the at least one extension 110 implemented may be based upon the signage intended to be retained by the at least one extension 110. For example, the shape, width, length, and/or depth of the fingers 112, 114 may be based on the thickness and/or weight of the signage intended to be retained by the at least one extension 110. Additionally or alternatively, the shape, width, length, and/or depth of the fingers 112, 114 may be different across different embodiments, with different characteristics resulting in different properties, such as durability. For example, the embodiments of the at least one extension 110 shown in the fourth top perspective 708 and the eighth top perspective 716 may offer increased durability over embodiments of the at least one extension 110 illustrated in the ninth top perspective 718, as the first and second fingers 112, 114 may each be relatively wider (e.g., and potentially relatively stronger, controlling for other variables) in embodiments of the fourth top perspective 708 and the eighth top perspective 716 relative to embodiments of the ninth top perspective 718.

As illustrated by the first top perspective 702, second top perspective 704, third top perspective 706, fourth top perspective 708, fifth top perspective 710, sixth top perspective 712, and thirteenth top perspective 726, the at least one extension 110 may be tapered. That is, in such embodiments, the first and second fingers 112, 114 may inwardly taper with an angle toward the groove 116. In some such embodiments, the distal ends 126, 136 of the fingers 112, 114 may be flat.

In some embodiments, such as embodiments illustrated by the sixth top perspective 712, the first and second fingers 112, 114 each may be relatively wider at the respective proximal ends 124, 134 than at respective distal ends 126, 136. For example, the first and second fingers 112, 114 may taper toward the distal ends 126, 136.

Conversely, in some other embodiments, such as embodiments illustrated by the seventh top perspective 714, the first and second fingers 112, 114 each may be relatively narrower at the respective proximal ends 124, 134 than at respective distal ends 126, 136, e.g., as a result of the aperture 226 formed by the first and second fingers 112, 114. For example, the first and second fingers 112, 114 may taper toward the proximal ends 124, 134.

As illustrated by the seventh top perspective 714, eighth top perspective 716, ninth top perspective 718, tenth top perspective 720, eleventh top perspective 722, and twelfth top perspective 724, the at least one extension 110 may be relatively straight. That is, in such embodiments, the first and second fingers 112, 114 may be relatively straight, and therefore have no an angle, from respective proximal ends 124, 134 to respective distal ends 126, 136. In some such embodiments, the distal ends 126, 136 of the fingers 112, 114 may be rounded.

According to various embodiments described herein, the groove 116 of the at least one extension 110 may comprise an aperture 226 that is proximate the body 104 of the apparatus 102. For example, various different shapes of an aperture that may be within the groove of the at least one extension 110 and proximate to the body 104 of the apparatus 102. In some aspects, the groove 116 of the at least one extension 110 may be configured in many different configurations. For example, the groove 116 may be include consistent dimensions such that the first and second fingers 112, 114 are evenly separated. However, in some aspects, the groove 116 may be tapered such that the separation of the first and second fingers 112, 114 is varied. For example, the groove 116 may be widest at a region close to the body 104 and narrows as the groove 116 extends away from the body 104. In some aspects, the groove 116 may comprise an aperture 226 (e.g., wing slit) adjacent the body 104, e.g., such that the aperture 226 may receive a correspondingly shaped portion of the signage to assist in holding the signage within the extension 110. For example, the aperture 226 or wing slit, e.g., as disclosed in the eighth perspective 716 and thirteenth perspective 726, may include a round or bulbous shape at a region adjacent the body 104 of the apparatus 102, and this round or bulbous shape may be wider than the groove 116, e.g., in order to prevent the signage from easily falling out from the apparatus 102.

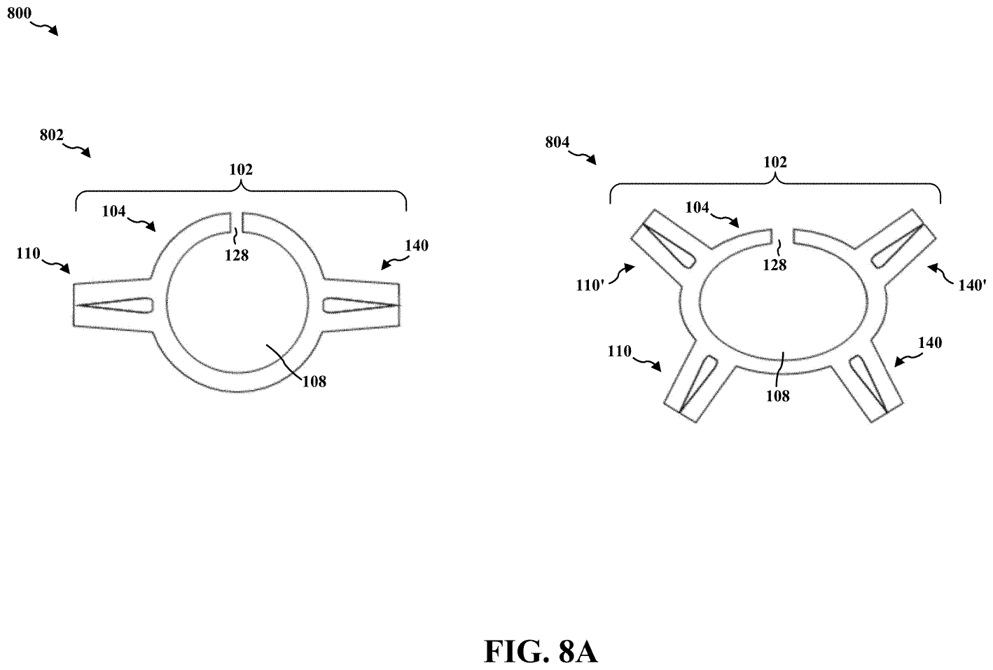

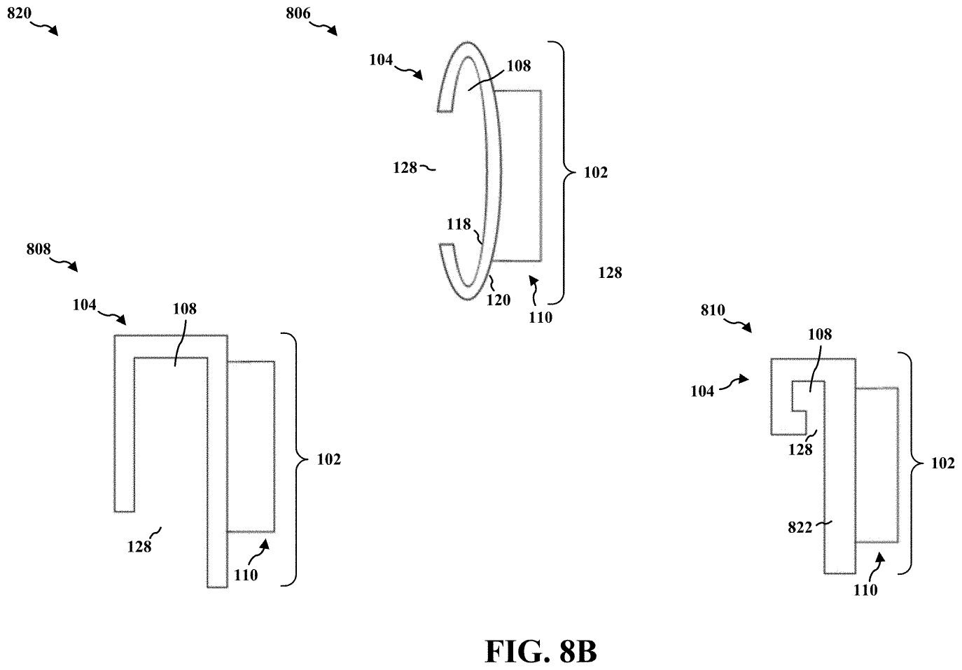

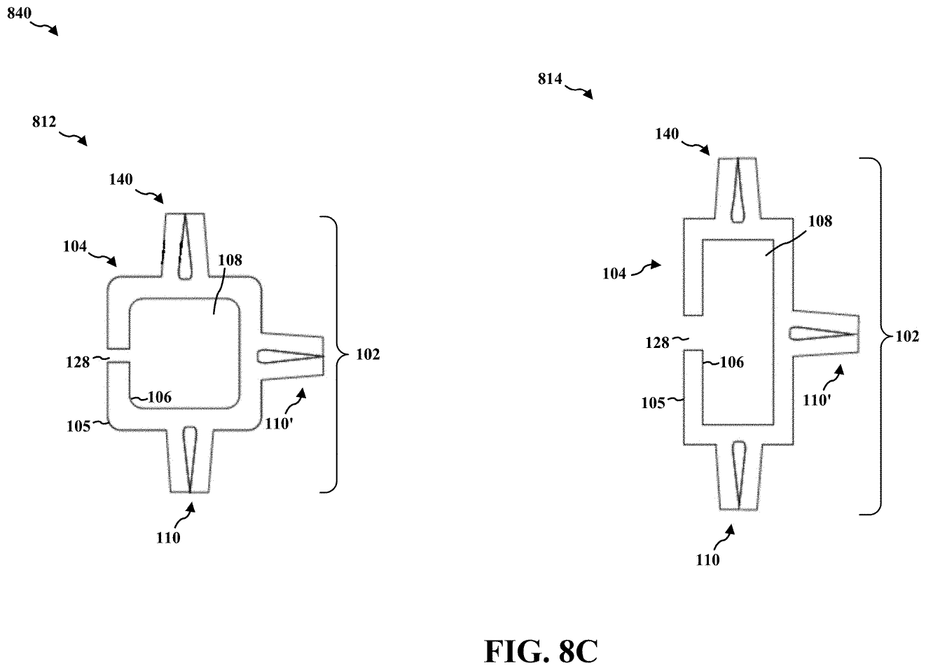

FIGS. 8A, 8B, and 8C are diagrams 800, 820, 840 illustrating various top perspectives of embodiments of the apparatus 102. According to some embodiments shown in FIGS. 8A, 8B, and 8C, the body 104 may be deformable at the opening 128, such that the size (e.g., width) of the opening 128 may be increased and the size (e.g., diameter) of the gap 108 may be commensurately increased. FIGS. 8A, 8B, and 8C may illustrate various embodiments of the apparatus 102 when the body 104 is in a default state/configuration in which no external forces are acting to deform the body 104 and increase sizes of the opening 128 and gap 108. In some other embodiments, however, the body 104 may be relatively rigid, and therefore, non-deformable.

The embodiments of the apparatus 102 implemented may be based upon the support structures intended to be engaged and/or retained by the apparatus 102. For example, the shape, width, length, and/or depth of the body 104 may be based on the size (e.g., thickness, width, diameter, etc.) of the support structure intended to be engaged and/or retained by the body 104. Additionally or alternatively, the shape, width, length, and/or depth of the body 104 may be different across different embodiments, with different characteristics resulting in different properties, such as durability.

Referring first to embodiments illustrated by the first top perspective 802, the body 104 may be a scalable round body, e.g., in which the body 104 is relatively circular or annular. The body 104 may be deformable, e.g., at the opening 128 so that the size (e.g., width) of the opening 128 may be increased to receive a support structure (e.g., a round pole) into the gap 108, which may also be increased in size (e.g., diameter) as the body 104 is deformed. When the body 104 is no longer deformed, the body 104 may return to a default state or configuration (e.g., as illustrated), e.g., based on elasticity and/or elastic force of the body 104. With the support structure positioned within the gap 108, the friction, tension, and/or other force(s) may retain the position of the apparatus 102 on the support structure.

The apparatus 102 may include two extensions 110, 140. The two extensions may be located on opposite sides of the body 104—e.g., one extension 110 may be 180° from another extension 140. While the extensions 110, 140 are illustrated as being substantially similar, the extensions 110, 140 may be different in some other embodiments. For example, one extension 110 may be any of the embodiments illustrated in FIG. 7, and the other extension 140 may be the same or different embodiment of any of the embodiments illustrated in FIG. 7.

The fingers 112, 114 of either or both extensions 110, 140 may form any of the embodiments of the groove 116 illustrated in FIG. 6, and may or may not form an aperture 226 of the groove 116.

According to embodiments illustrated by the second top perspective 804, the body 104 may be a scalable oval body, e.g., in which the body 104 is relatively oval. The body 104 may be deformable, e.g., at the opening 128 so that the size (e.g., width) of the opening 128 may be increased to receive a support structure (e.g., a round pole) into the gap 108, which may also be increased in size (e.g., diameter) as the body 104 is deformed. When the body 104 is no longer deformed, the body 104 may return to a default state or configuration (e.g., as illustrated), e.g., based on elasticity and/or elastic force of the body 104. With the support structure positioned within the gap 108, the friction, tension, and/or other force(s) may retain the position of the apparatus 102 on the support structure.

The apparatus 102 may include four extensions 110, 110′, 140, 140′. Each of four extensions may be located approximately 90° from two other extensions around the body 104 and approximately 180° from the respective further extension around the body 104, although the degrees of separation may be different in some embodiments.

The extensions 110, 110′, 140, 140′ may be the same or may be different. For example, each of the extensions 110, 110′, 140, 140′ may be any of the embodiments illustrated in FIG. 7, and respective first and second fingers 112, 114 of each of the extensions 110, 110′, 140, 140′ may form any of the embodiments of the groove 116 illustrated in FIG. 6, and may or may not form an aperture 226 of the groove 116.

Referring to embodiments illustrated by the third top perspective 806, the body 104 may be a scalable flat oval body, e.g., in which the body 104 is substantially oval. In some embodiments, the distance between the first end 118 and the second end 120, which may also be referred to as “height,” may be relatively small—e.g., inclusively between 0.1 inches and one (1) inches. However, other dimensions of the height of the body 104 are possible without departing from the scope of the present disclosure.

According to some illustrative configurations, the at least one extension 110 may be substantially perpendicular to the body 104. For example, the at least one extension 110 may appear to “hang” from the body 104. Thus, in some embodiments shown by the third top perspective 806, signage may be retained in an overhead position and hang down in front of an intended audience.

In some embodiments of the third top perspective 806, the body 104 may be deformable, e.g., at the opening 128 so that the size (e.g., width) of the opening 128 may be increased to receive a support structure into the gap 108, which may also be increased in size as the body 104 is deformed. In some other aspects, the body 104 may be substantially rigid, and may not be intended to be deformable.

According to embodiments shown by the fourth top perspective 808, the body 104 may be a scalable varied body, e.g., in which the body 104 includes a plurality of approximate right angles. For example, the body 104 may be substantially rectangular or square; however, one side and/or a portion of one side may be missing, e.g., in order to form the opening 128.

According to some illustrative configurations, the at least one extension 110 may be substantially perpendicular to the body 104. For example, the at least one extension 110 may appear to “hang” from the body 104. Thus, in some embodiments shown by the fourth top perspective 808, signage may be retained in an overhead position and hang down in front of an intended audience.

In some embodiments of the fourth top perspective 808, the body 104 may be configured to receive a support structure that has an exterior surface including one or more substantially right angles—e.g., the body 104 may be configured to accommodate support structures that are rails, tracks, or the like. Potentially, the body 104 may be deformable, e.g., at the opening 128 so that the size (e.g., width) of the opening 128 may be increased to receive a support structure into the gap 108, which may also be increased in size as the body 104 is deformed. In some other embodiments, however, the body 104 may be substantially rigid, and may not be intended to be deformable.

Referring to embodiments shown by the fifth top perspective 810, the body 104 may be a scalable flat body, e.g., in which the body 104 includes a plurality of approximate right angles, as well as a “lip” 822, which may extend beyond the opening 128 and may be configured to support the at least one extension 110. Apart from the lip 822, the body 104 may be substantially rectangular or square; however, a portion of one side may be missing, e.g., in order to form the opening 128.

According to some illustrative configurations, the at least one extension 110 may be substantially perpendicular to the body 104. For example, the at least one extension 110 may appear to “hang” from the body 104. Thus, in some embodiments shown by the fifth top perspective 810, signage may be retained in an overhead position and hang down in front of an intended audience.

In some embodiments of the fifth top perspective 810, the body 104 may be configured to receive a support structure that has an exterior surface including one or more substantially right angles—e.g., the body 104 may be configured to accommodate support structures that are rails, tracks, rods, or the like. Potentially, the body 104 may be deformable, e.g., at the opening 128 so that the size (e.g., width) of the opening 128 may be increased to receive a support structure into the gap 108, which may also be increased in size as the body 104 is deformed. In some other embodiments, however, the body 104 may be substantially rigid, and may not be intended to be deformable.

Referring to embodiments illustrated by the sixth top perspective 812, the body 104 may be a scalable square body, e.g., in which the body 104 is relatively square shaped. The inner surface 106 of the body 104 may include a plurality of angles that are approximately 90°. Potentially, however, the corners of the inner surface 106 at which the approximately right angles occur may be rounded (e.g., as illustrated).

The body 104 may be deformable, e.g., at the opening 128 so that the size (e.g., width) of the opening 128 may be increased to receive a support structure (e.g., an approximately square-shaped pole, rod, rail, track, etc.) into the gap 108, which may also be increased in size (e.g., width and/or length) as the body 104 is deformed. When the body 104 is no longer deformed, the body 104 may return to a default state or configuration (e.g., as illustrated), e.g., based on elasticity and/or elastic force of the body 104. With the support structure positioned within the gap 108, the friction, tension, and/or other force(s) may retain the position of the apparatus 102 on the support structure.

The apparatus 102 may include three extensions 110, 110′, 140. Two extensions 110, 140 may be located on opposite sides of the body 104—e.g., one extension 110 may be approximately 180° from another extension 140. A third extension 110′ may be approximately 90° from the other extensions 110, 140. For example, the third extension 110′ may be located on a side of the outer surface 105 opposite the opening 128—e.g., the third extension 110′ may be approximately 180° from the opening 128.

Each of the extensions 110, 110′, 140 may be any of the embodiments illustrated in FIG. 7. Further, the fingers 112, 114 of any of the extensions 110, 110′, 140 may form any of the embodiments of the groove 116 illustrated in FIG. 6, and may or may not form an aperture 226 of the groove 116.

Referring to embodiments illustrated by the seventh top perspective 814, the body 104 may be a scalable rectangle body, e.g., in which the body 104 is relatively rectangular. The inner surface 106 of the body 104 may include a plurality of angles that are approximately 90°. Potentially, however, the corners of the inner surface 106 at which the approximately right angles occur may be rounded.

The body 104 may be deformable, e.g., at the opening 128 so that the size (e.g., width) of the opening 128 may be increased to receive a support structure (e.g., an approximately rectangular pole, rod, rail, track, railing, bannister, etc.) into the gap 108, which may also be increased in size (e.g., width and/or length) as the body 104 is deformed. When the body 104 is no longer deformed, the body 104 may return to a default state or configuration (e.g., as illustrated), e.g., based on elasticity and/or elastic force of the body 104. With the support structure positioned within the gap 108, the friction, tension, and/or other force(s) may retain the position of the apparatus 102 on the support structure.

The apparatus 102 may include three extensions 110, 110′, 140. Two extensions 110, 140 may be located on opposite sides of the body 104—e.g., one extension 110 may be approximately 180° from another extension 140. A third extension 110′ may be approximately 90° from the other extensions 110, 140. For example, the third extension 110′ may be located on a side of the outer surface 105 opposite the opening 128—e.g., the third extension 110′ may be approximately 180° from the opening 128.

Each of the extensions 110, 110′, 140 may be any of the embodiments illustrated in FIG. 7. Further, the fingers 112, 114 of any of the extensions 110, 110′, 140 may form any of the embodiments of the groove 116 illustrated in FIG. 6, and may or may not form an aperture 226 of the groove 116.

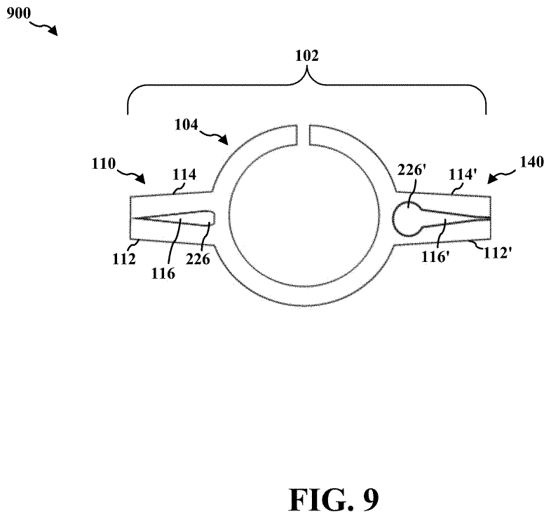

FIG. 9 is a diagram 900 of a top perspective illustrating some embodiments of the apparatus 102. According to the illustrated embodiment, the apparatus 102 includes two extensions 110, 140. A first extension 110 includes respective first and second fingers 112, 114 forming a groove 116 that is angularly tapered toward the distal ends 126, 136 of the fingers 112, 114. The base of the groove 116, closest to the body 104, may be the widest portion of the groove 116. In some embodiments, this widest portion of the groove 116 may be regarded as an aperture 226.

The second extension 140 may be similar to the first extension 110; however, while the respective first and second fingers 112′, 114′ may form a groove 116 that is angularly tapered toward the distal ends 126, 136 of the fingers 112′, 114′, the fingers 112′, 114′ may form an aperture 226′ that is round or bulbous in shape. Such a round or bulbous shaped aperture 226 may be wider than the groove 116, such that signage may be received into the groove 116 by way of the aperture 226—e.g., the aperture 226 may serve as an entry point for signage, allowing the fingers 112′, 114′ to be wedged apart so that the signage may be more easily received and positioned within the groove 116. Furthermore, the aperture 226 may be configured to prevent the signage from becoming dislodged and/or moved out of position.

In some further embodiments, the aperture 226′ may serve as a channel configured to receive a rod, such as rod attached to a “service flag.” For example, a service flag may be an approach to signaling a waiter or other service staff that some service is requested—e.g., a user may insert the service flag into the aperture 226 to provide a visual indication to service staff that the user is ready to order at a restaurant or bar. The aperture 226 may function as a guide or wayfinding bracket.

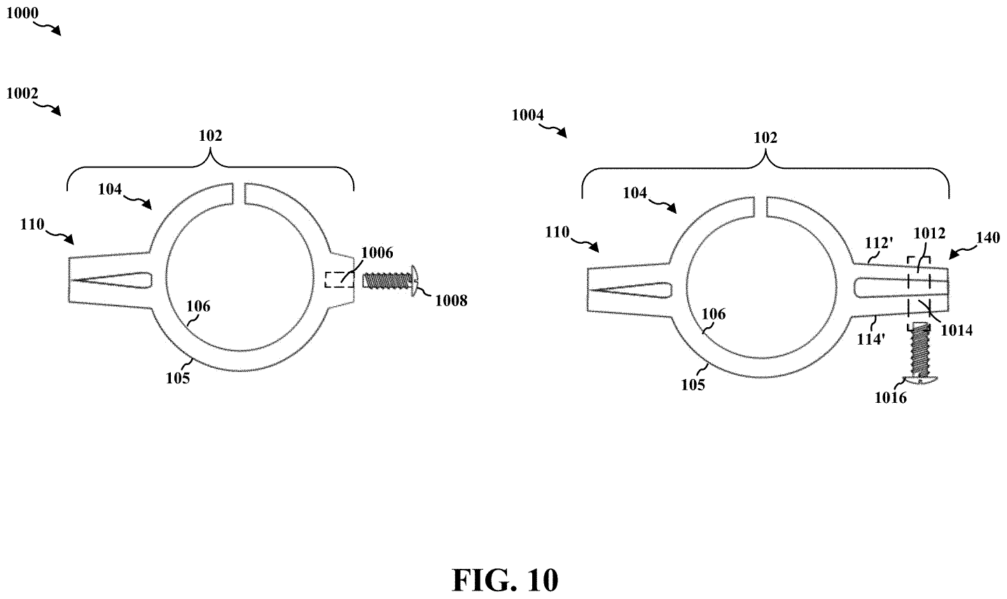

FIG. 10 is a diagram 1000 of top perspectives 1002, 1004 illustrating some embodiments of the apparatus 102. According some embodiments of the first top perspective 1002, the apparatus 102 includes one extension 110 configured to receive and retain signage. On another portion of the outer surface 105, the body 104 includes a fastening mechanism 1006, which may be a threaded hole to receive a screw, an unthreaded hole to receive a pin, another hole to receive a bolt, or another mechanism configured to receive a fastener 1008. The fastener 1008 may be a threaded screw, unthreaded pin, a bolt, etc.

In some embodiments, the fastening mechanism 1006 may be configured to retain the position of the signage positioned in the groove 116 and retained by the extension 110. For example, the fastening mechanism 1006 may receive the fastener 1008, which may be tightened in the fastening mechanism 1006. With the fastener 1008 secured therein (e.g., tightened), the fastening mechanism 1006 may reduce the possibility of deformation of the fingers 112, 114 of the extension 110 and/or may increase the rigidity of the fingers 112, 114 of the extension 110 (e.g., so that the friction between the fingers 112, 114 and the signage is increased).

In some additional or alternative embodiments, the fastening mechanism 1006 may be configured to retain the position of the apparatus 102 on a support structure. For example, the fastening mechanism 1006 may receive the fastener 1008, which may be tightened in the fastening mechanism 1006. With the fastener 1008 secured therein (e.g., tightened), the fastening mechanism 1006 may reduce the possibility of deformation of the body 104 and/or may increase the rigidity of the body 104 (e.g., so that the friction between the body 104 and the support structure is increased).

According some embodiments of the second top perspective 1004, the apparatus 102 includes two extensions 110, 140. The second extension 140, however, may include fastening mechanisms 1012, 1014 respectively on the first and second fingers 112′, 114′. For example, the first finger 112′ may include a first fastening mechanism 1012 and the second finger 114′ may include a second fastening mechanism 1014. The first and second fastening mechanisms 1012, 1014 may be complementary, and may be lined up to receive a fastener 1016.

The first and second fastening mechanisms 1012, 1014 each may be a threaded hole to receive a screw, an unthreaded hole to receive a pin, another hole to receive a bolt, or another mechanism configured to receive a fastener 1016.

Correspondingly, the fastener 1016 may be a threaded screw, unthreaded pin, a bolt, etc.

In some embodiments, the fastening mechanisms 1012, 1014 may be configured to retain the position of the signage positioned in the groove 116 and retained by the extension 110. For example, the fastening mechanisms 1012, 1014 may receive the fastener 1016, which may be tightened in the fastening mechanisms 1012, 1014. With the fastener 1016 secured therein (e.g., tightened), the fastening mechanisms 1012, 1014 may reduce the possibility of deformation of the fingers 112′, 114′ of the extension 140 and/or may increase the rigidity of the fingers 112′, 114′ of the extension 140 (e.g., so that the friction between the fingers 112, 114 and the signage is increased). For example, signage may be effectively “locked” or “bolted” into the extension 140.

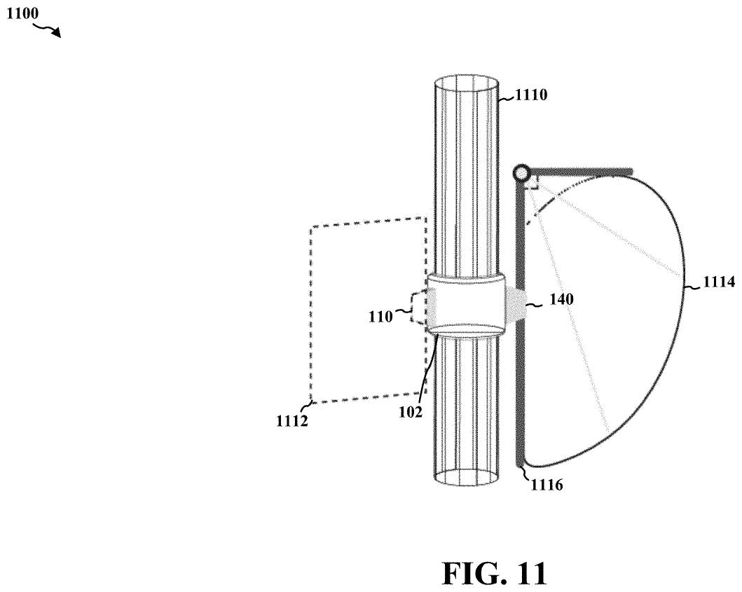

FIG. 11 is a diagram 1100 of a perspective view of an embodiment of the apparatus 102. The apparatus 102 may be positioned on a support structure 1110, which may be a round pole—e.g., the support structure 1110 may be an umbrella pole or similar pole structure. The apparatus 102 may retain its position on the support structure 1110 via elastic force, friction, tension, etc., such as the friction between the inner surface 106 of the apparatus 102 and the outer surface of the support structure 1110.

The apparatus 102 may include two extensions 110, 140. The first extension 110 may retain a signage 1112. For example, the signage 1112 may be an advertisement, a menu, etc. The second extension 140 may retain a service flag 1114. For example, the service flag 1114 may be connected with a rod 1116, and the rod 1116 may be positioned through the aperture 226′ of the second extension (see, e.g., FIG. 9, supra). The flag 1114 or marker may be utilized to indicate a request for assistance. For example, a user may alter the position the flag 1114 or marker such that the altered position is an indication for request for service or assistance. In some aspects, the flag 1114 or marker may be screwed onto the second extension 140 (or body 104). In such aspects, the flag 1114 or marker may be configured to be pivoted or adjusted to indicate a request for service. The flag 1114 or marker may be configured to pivot about the fastener (e.g., screw, bolt, pin) that secures the flag or marker to the apparatus 102, or may include other pivoting means separate from the fastener (e.g., screw, bolt, pin) to allow the flag or marker to indicate a request for service.

The apparatus 102 may be configured to wrap around different structures (e.g., poles, support structure 1110, etc.) having various dimensions (e.g., widths, diameters, etc.) and/or various sizes and/or various shapes. For example, the apparatus 102 may have a circular shape, an oval shape, a flat shape, a rectangular shape, a square shape, a flat oval shape, or a varied shape, such that the apparatus 102 may wrap around the support structure and/or be mounted onto such support structure, and provide a holding force to hold the signage at the at least one extension 110. The at least one extension 110 may be configured to hold various thicknesses of signage. At least one advantage of the invention is that the apparatus 102 is designed to be user friendly in installation by not requiring tools for the installer to attach to a formed support structure (e.g., pole, etc.). The apparatus 102 may be adaptable in form, such that the apparatus 102 may be an all-in-one fixed component, while in some aspects, configured to have interchangeable additions to add a service flag, as discussed herein. The apparatus 102 may be designed with a smooth or ridged bore and extruded with slots to create an interference fit with the signage (or other object) inserted into the extensions that may be perpendicular to the outer surface 105 of the body 104.

The apparatus 102 may be comprised of one or more different materials, such as but not limited to rubber, urethane, and/or silicone material. The apparatus 102 may be any form of flexible plastic or other elastic material that wraps around support structures of various orientations (e.g., vertical, diagonal, horizontal, etc.) and/or structures that may be in the form of round, square, oval, multi-faceted, flat, or the like. The apparatus 102 being flexible and/or elastic allows the apparatus 102 to return to its original shape when removed from a support structure. The apparatus 102 being flexible and/or elastic may assist in the apparatus 102 exerting a holding force (e.g., friction) at the at least one extension 110 to hold retain the signage, due to apparatus 102 trying to counter the force exerted onto the apparatus 102 by the support structure when mounted onto the support structure.

The apparatus 102 may be utilized for outdoor and/or indoor applications, e.g., to be used as a marketing or informational tool. The apparatus 102 may be composed of material(s) that may be calibrated for tension, friction, elasticity, and/or rebound, such that the apparatus 102 may return to its original shape after removal from a support structure. The apparatus 102 may be scalable to fit various widths and/or lengths of various support structures. The at least one extension 110 may be configured to hold various advertising, marketing, and/or informational materials (e.g., print materials) of various sizes. At least one advantage of the apparatus 102 is that the signage (e.g., advertising materials) may be easily inserted or removed from the at least one extension 110.

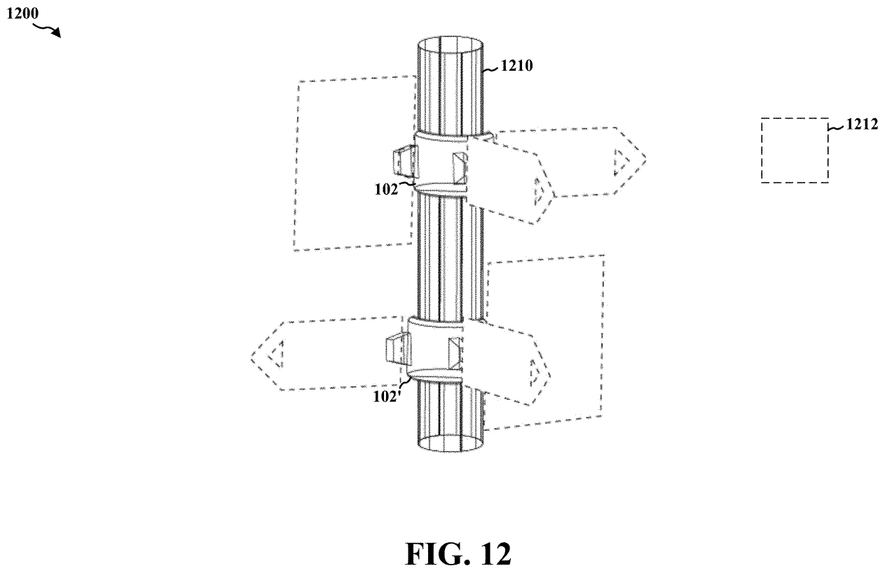

FIG. 12 is a diagram 1200 of a perspective view of an embodiment of two apparatuses 102, 102′. The apparatuses 102, 102′ may be positioned on a support structure 1110, which may be a round pole—e.g., the support structure 1210 may be an umbrella pole or similar pole structure. The apparatuses 102, 102′ may retain their respective positions on the support structure 1210 via elastic force, friction, tension, etc. Each of the apparatus 102, 102′ may include multiple extensions, and the multiple extensions of each of the apparatus 102, 102′ may be configured to simultaneously retain respective signage 1212.

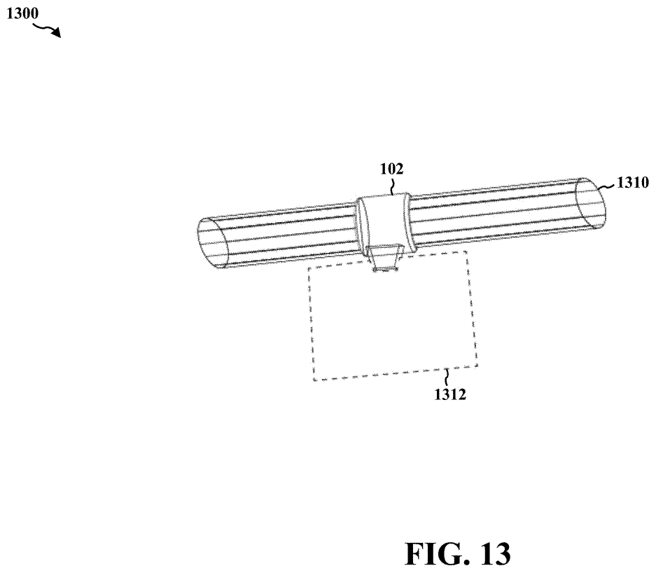

FIG. 13 is a diagram 1300 of a perspective view of an embodiment of an apparatus 102 mounted on a support structure 1310. The support structure 1310 may be horizontally oriented, such as an overhead railing. The apparatus 102 may be configured to retain signage 1312 in a position in which the signage 1312 is hanging down. In some other embodiments, the apparatus 102 may be configured to retain signage in a position in which the signage is sticking up.

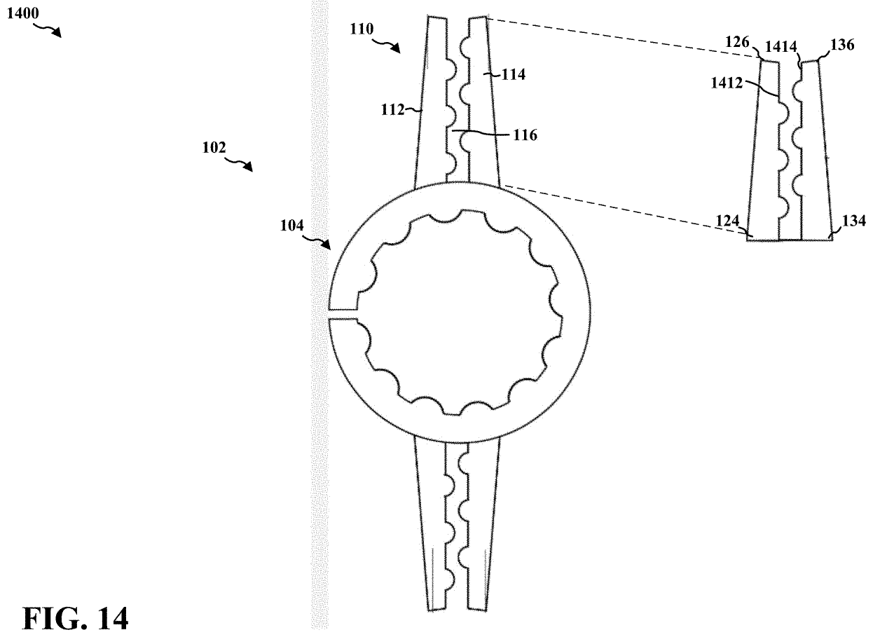

FIG. 14 is a diagram 1400 of a top perspective view of embodiments of the apparatus 102. The apparatus 102 may include at least one extension 110 having first and second fingers 112, 114. The first and second fingers 112, 114 may include respective inner surfaces 1412, 1414. The inner surfaces 1412, 1414 may be textured.

In some aspects, the inner surfaces 1412, 1414 of the first and second fingers 112, 114 may include textured surfaces to assist in holding the signage within the extension 110. The textured surfaces 1412, 1414 of the first and second fingers 112, 114 may be configured in a manner similar to the inner surfaces of the body 104 as shown in FIGS. 3A through 3D. For example, in some embodiments, the textured surfaces 1412, 1414 of the first and second fingers 112, 114 may be coarse or may have a grain similar to sand paper.

Illustratively, the at least one extension 110 of FIG. 14 includes inner surfaces 1412, 1414 of the first and second fingers 112, 114 having rounded bumps or contours. In some other aspects, inner surfaces 1412, 1414 of the first and second fingers 112, 114 may have cylindrical waves or cylindrical contours. The texture of the inner surfaces 1412, 1414 of the first and second fingers 112, 114 may extend from respective proximal ends 124, 134 to respective distal ends 126, 136.

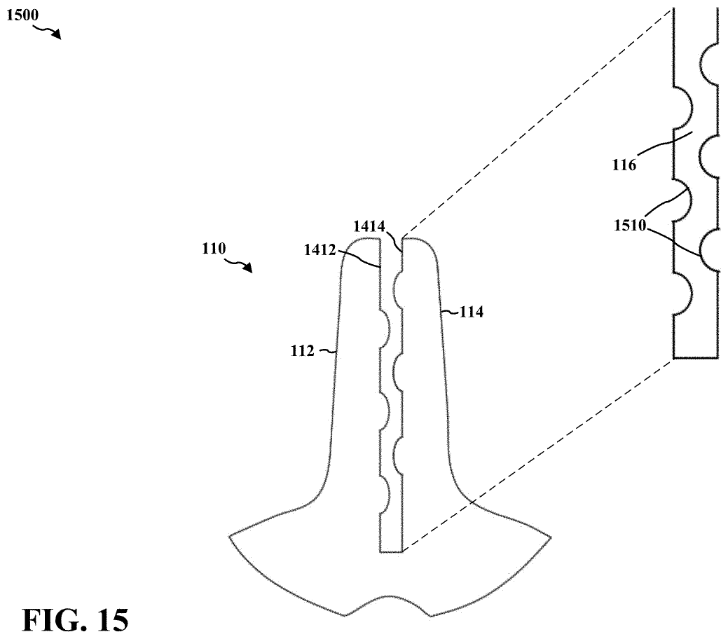

FIG. 15 is a diagram 1500 of a top perspective view of embodiments of the at least one extension 110. The at least one extension 110 may have first and second fingers 112, 114 having respective inner surfaces 1412, 1414 that are textured. For example, the inner surface 1412, 1414 may include contours 1510, which may be raised bumps or cylindrical contours or waves, which may run perpendicular to the groove 116.

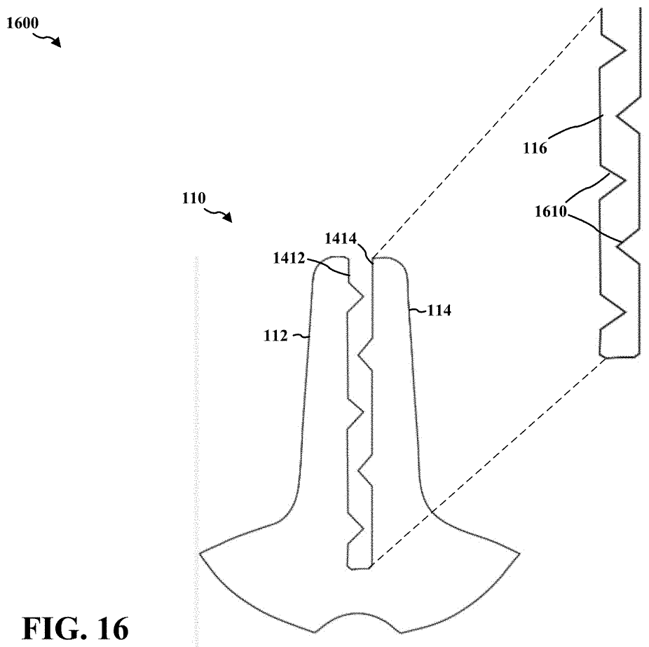

FIG. 16 is a diagram 1600 of a top perspective view of embodiments of the at least one extension 110. The at least one extension 110 may have first and second fingers 112, 114 having respective inner surfaces 1412, 1414 that are textured. For example, the inner surface 1412, 1414 may include triangular features 1610, which may be raised triangular or pyramid shapes. Potentially, the triangular features 1610 may run perpendicular to the groove 116.

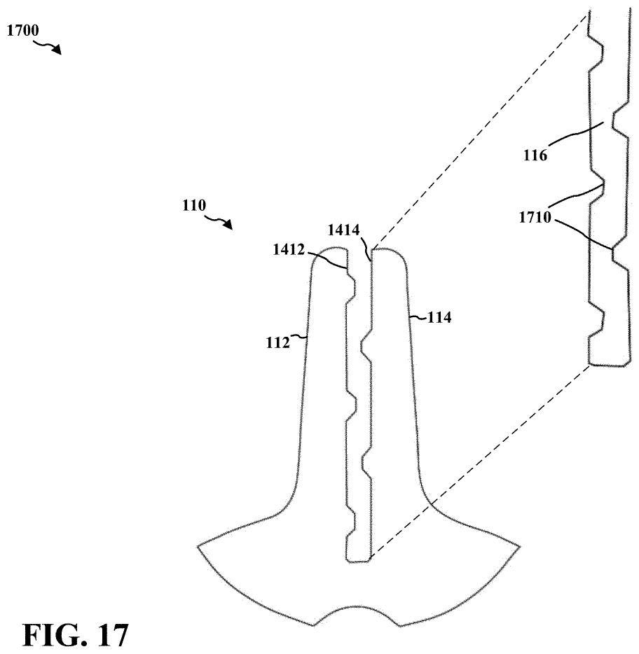

FIG. 17 is a diagram 1700 of a top perspective view of embodiments of the at least one extension 110. The at least one extension 110 may have first and second fingers 112, 114 having respective inner surfaces 1412, 1414 that are textured. For example, the inner surface 1412, 1414 may include trapezoidal features 1710, which may be raised shapes having tapering toward a flat top portion. Potentially, the trapezoidal features 1710 may run perpendicular to the groove 116. In some aspects, the trapezoidal features 1710 on the first inner surface 1412 may be interlocking and/or alternating with the trapezoidal features 1710 on the second inner surface 1414.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus, comprising:
a body having an outer surface and an inner surface, the inner surface at least partially circumscribing a gap configured to receive a support structure;
at least one extension extending from the outer surface of the body and having a first finger and a second finger separated by a groove, at least the first finger being deformable away from the second finger to increase the separation by the groove and at least the first finger being configured to exert force toward the second finger when deformed.

2. The apparatus of claim 1, wherein the body is unconnected at a lengthwise opening into the gap that is at least partially circumscribed by the inner surface, and the body is deformable so that a size of the lengthwise opening is able to be increased.

3. The apparatus of claim 2, wherein the body is deformable based on the body being unconnected at the lengthwise opening.

4. The apparatus of claim 1, wherein at least a distal end of the first finger is configured to exert force toward a distal end of the second finger to retain a signage at least partially positioned in the groove.

5. The apparatus of claim 1, wherein the at least one extension is configured to form an aperture of the groove at proximal ends of the first finger and the second finger.

6. The apparatus of claim 1, wherein each of the inner surface and the outer surface is annular.

7. The apparatus of claim 1, wherein the inner surface forms a plurality of right angles.

8. The apparatus of claim 1, wherein the at least one extension is perpendicular to the outer surface of the body.

9. The apparatus of claim 8, wherein the inner surface comprises a contoured or textured surface.

10. An apparatus, comprising:
a collar configured to engage with a support structure;
a first protrusion outwardly extending from the collar and having a first proximal end connected with the collar; and
a second protrusion outwardly extending from the collar and having a second proximal end connected with the collar, the first proximal end being separated from the second proximal end, and at least a first distal end of the first protrusion being configured to apply pressure toward a second distal end of the second protrusion to retain a signage therebetween.

11. The apparatus of claim 10, wherein the first protrusion is angled toward the second protrusion and the second protrusion is angled toward the first protrusion such that a distance between the first proximal end and the second proximal end is greater than a distance between the first distal end and the second distal end.

12. The apparatus of claim 10, wherein the collar includes a plurality of raised surfaces configured to facilitate the engagement with the support structure.

13. The apparatus of claim 12, wherein each of the plurality of raised surfaces comprises a semicylindrical surface.

14. The apparatus of claim 10, further comprising:
a third protrusion outwardly extending from the collar and having a third proximal end connected with the collar; and
a fourth protrusion outwardly extending from the collar and having a fourth proximal end connected with the collar, the third proximal end being separated from the fourth proximal end, and a third distal end of the third protrusion contacting a fourth distal end of the fourth protrusion.

15. The apparatus of claim 10, wherein the collar is unconnected across a side surface of the collar.

16. An apparatus, comprising:
a cylindrical bracket portion having at least partially surrounding an open space; and
at least one signage retention feature on an exterior of the cylindrical bracket portion, the at least one signage retention feature including a first protrusion and a second protrusion, the first and second protrusions being configured to exert opposing forces on signage positioned therebetween.

17. The apparatus of claim 16, wherein the at least one signage retention feature is molded to the cylindrical bracket portion.

18. The apparatus of claim 16, wherein the first and second protrusions are separated by a groove and angularly extend toward one another away from the cylindrical bracket portion.

19. The apparatus of claim 16, wherein the cylindrical bracket portion includes a lengthwise slot through to the open space, and the cylindrical bracket is configured to receive a support structure into the open space through the lengthwise slot.

20. The apparatus of claim 19, wherein the cylindrical bracket includes an elastic force that maintains a position of the apparatus on the support structure.
